(19) United States
(12) Patent Application Publication
(10) Pub. No.: US 2024/0326863 A1
(43) Pub. Date: Oct. 3, 2024

(54) DETECTION AND AVOIDANCE OF CAR DOORING OF CYCLISTS

(71) Applicant: Volvo Car Corporation, Gothenburg (SE)

(72) Inventors: Oswaldo Perez Barrera, Gothenburg (SE); Anders Lennartsson, Gothenburg (SE)

(21) Appl. No.: 18/192,397

(22) Filed: Mar. 29, 2023

(51) Int. Cl. B60W 60/00; B60W 30/09; B60W 30/095; B60W 40/105

(52) U.S. Cl. CPC B60W 60/0011; B60W 30/09; B60W 30/0956; B60W 40/105; B60W 60/0017; B60W 2520/06; B60W 2554/20; B60W 2554/4026; B60W 2554/4042; B60W 2554/4044

(57) ABSTRACT

Various systems and methods are presented regarding utilizing technology onboard a vehicle to minimize road traffic accidents between cyclists and vehicles. A first vehicle can be operating in any of an autonomous, partially autonomous, or non-autonomous manner. By utilizing onboard technology/artificial intelligence, the first vehicle can detect both a cyclist navigating a street and a parked vehicle that is proximate enough to the cyclist for the possibility of dooring event to occur if a door of the parked vehicle was opened into the path of the cyclist. The first vehicle can determine a respective velocity of the cyclist and a location of the door on the parked vehicle. Accordingly, the vehicle can preemptively adjust its operation to prevent being involved in the effects of the dooring incident based on a determined probability of a dooring event occurring/likely to occur, e.g., situation is safe, moderately safe, or dangerous.

### TECHNICAL FIELD

This application relates to techniques facilitating operation of a vehicle to detect and avoid injury of a cyclist involved in a car dooring incident.

### BACKGROUND

With roads being commonly shared between drivers, cyclists, and pedestrians, the potential for accidents is of concern, and happens too frequently. One common accident is “dooring”, where a driver opens the car door into the path of another road user, typically a cyclist. Dooring involves a driver or passenger opening a vehicle door without previously checking in the rearview/side mirror, over their shoulder, and suchlike, wherein the open door is in the path of a cyclist. Where there is sufficient time to respond and the cyclist sees the door being opened, the cyclist may be able to avoid the door being opened by altering their course around the door, but that may cause the cyclist to veer into an adjacent lane (e.g., out of a bicycle lane and into vehicle traffic). In the worst case, the cyclist collides with the door, which can further lead them to fall into the path of moving traffic. To minimize the risk of being doored, cyclists will often ride as far away from parked cars as possible, which further increases the likelihood of the cyclist straying into traffic to avoid a door being opened.

The above-described background is merely intended to provide a contextual overview of some current issues and is not intended to be exhaustive. Other contextual information may become further apparent upon review of the following detailed description.

### SUMMARY

The following presents a summary to provide a basic understanding of one or more embodiments described herein. This summary is not intended to identify key or critical elements, or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented to mitigate dooring incidents between vehicles and cyclists.

According to one or more embodiments, a system can be located on a first vehicle, wherein the first vehicle can be operating at least autonomously, partially autonomously, and suchlike. The system can comprise a memory that stores computer executable components and a processor that executes the computer executable components stored in the memory. The computer executable components can comprise an accident component configured to determine probability of a cyclist being involved in a dooring incident, wherein the cyclist is cycling on a road the first vehicle is navigating. In an embodiment, the accident component can be further configured to determine a proximity of the first vehicle to an inferred location of the dooring incident, and in response to a first determination that the determined probability is above a probability threshold, generate a first instruction for the first vehicle to preemptively avoid hitting the cyclist.

In an embodiment, the first instruction can comprise at least one of: reduce velocity of the first vehicle, stop motion of the first vehicle, or navigate the first vehicle to avoid the cyclist.

In a further embodiment, the computer executable components can further comprise a vehicle detection component configured to detect a presence of a parked vehicle. In response to detecting the presence of the parked vehicle, the vehicle detection component can be further configured to determine a direction in which the parked vehicle is facing and transmit a notification of the parked vehicle being detected and the direction that the parked vehicle is facing. In an embodiment, the vehicle detection component can be further configured to determine location of a door on the parked vehicle, wherein the door is proximate to a route being navigated by the cyclist.

In a further embodiment, the computer executable components can further comprise a cyclist component configured to determine speed of travel of the cyclist; determine direction of travel of the cyclist; and transmit a notification of the determined speed of travel of the cyclist and the determined direction of travel of the cyclist.

In a further embodiment, the computer executable components can further comprise a vehicle operation component configured to: generate a current speed of the first vehicle; a direction of travel of the first vehicle; and report the current speed of the first vehicle and the direction of travel of the first vehicle to the accident component.

In a further embodiment, the accident component can be further configured to determine probability of a cyclist being involved in a dooring incident based on at least one of: the parked vehicle is parked facing the direction of travel the cyclist is riding; the speed of the cyclist; a first time at which the cyclist will be proximate to the door of the parked vehicle; a speed of the first vehicle; or a second time at which the first vehicle will be proximate to the door of the parked vehicle.

In an embodiment, the accident component can be further configured to in response to a determination that the first time at which the cyclist is proximate to the door of the parked vehicle is less than a first elapsed time and the second time at which the first vehicle will be proximate to the door of the parked vehicle is less than a second elapsed time generate the first instruction to preemptively avoid hitting the cyclist. In an embodiment, the first elapsed time is less than three seconds, and the second elapsed time is less than three seconds. In a further embodiment, in response to the determination that the determined probability is below the probability threshold, the accident component can be further configured to generate a second instruction to maintain current operation of the first vehicle.

In another embodiment, the cyclist component can be further configured to determine a height of the cyclist, wherein in response to the height of the cyclist being above a height threshold, the cyclist is determined to be an adult or in response to the height of the cyclist being below a height threshold, the cyclist is determined to be a child.

In other embodiments, elements described in connection with the disclosed systems can be embodied in different forms such as computer-implemented methods, computer program products, or other forms. For example, in an embodiment, a computer-implemented method can be performed by a device operatively coupled to a processor, wherein the device can be located on a first vehicle that is operating in at least a partially autonomous manner. In an embodiment, the method can comprise detecting a presence of a cyclist riding along a road being navigated by the first vehicle; detecting a vehicle parked on the road; determining a direction in which the parked vehicle is facing; and in response to determining the parked vehicle is facing the same direction as a direction of travel of the cyclist, determining a probability of a dooring incident occurring between the cyclist and the parked vehicle.

In an embodiment, the method can further comprise determining a first time at which the cyclist will be proximate at the parked vehicle and further determining a second time at which the first vehicle will be proximate to first vehicle. In another embodiment, in the event of the first time and the second time being substantially the same, controlling operation of the first vehicle to at least one of: reduce velocity of the first vehicle; stop motion of the first vehicle; or navigate the first vehicle to avoid the cyclist.

In another embodiment, the method can further comprise in the event of the first time and the second time not being substantially the same, maintaining current operation of the first vehicle.

In a further embodiment, the method can further comprise, wherein the determining of the first time at which the cyclist will be proximate at the parked vehicle can be based on at least one of: speed of travel of the cyclist or direction of travel of the cyclist. In another embodiment, the method can further comprise, wherein the determining of the second time at which the first vehicle will be proximate at the parked vehicle can be based on at least one of speed of travel of the first vehicle or direction of travel of the first vehicle.

Further embodiments can include a computer program product comprising a computer readable storage medium having program instructions embodied therewith, the program instructions executable by a processor, located on a first vehicle, can cause the processor to detect a presence of a cyclist riding along a road being navigated by the first vehicle, and further detect a vehicle parked on the road and a direction in which the parked vehicle is facing. In an embodiment, the program instructions can further cause the processor to, in response to determining the parked vehicle is facing the same direction as a direction of travel of the cyclist, determine a probability of a dooring incident occurring between the cyclist and the parked vehicle. In another embodiment, the program instructions can further cause the processor to determine a first time at which the cyclist will be proximate at the parked vehicle, and further determine a second time at which the first vehicle will be proximate to first vehicle. In an embodiment, the program instructions can further cause the processor to, in the event of the first time and the second time being substantially the same, operate the first vehicle to at least one of: reduce velocity of the first vehicle; stop motion of the first vehicle; or navigate the first vehicle to avoid the cyclist. In another embodiment, in an event of the first time and the second time not being substantially the same, the program instructions can be further executable by the processor to cause the processor to maintain current operation of the first vehicle.

In a further embodiment, the determination of the first time at which the cyclist will be proximate at the parked vehicle can be based on at least one of: speed of travel of the cyclist or direction of travel of the cyclist. In another embodiment, the determination of the second time at which the first vehicle will be proximate at the parked vehicle can be based on at least one of speed of travel of the first vehicle or direction of travel of the first vehicle.

An advantage of the one or more systems, computer-implemented methods, and/or computer program products can be utilizing various systems and technologies located on a first vehicle to identify the possibility of a dooring may occur, and in response to the determination, the first vehicle preemptively changes operation to mitigate the chance of collision by the first vehicle with the cyclist as a result of the dooring accident. By identifying the potential of a dooring situation occurring the first vehicle can take responsive action such as slow down, stop, change driving lane, and suchlike, thereby reducing the likelihood of the first vehicle bring further involved in an accident arising from a cyclist/car dooring.

### DESCRIPTION OF THE DRAWINGS

One or more embodiments are described below in the Detailed Description section with reference to the following drawings.

FIG. 1 illustrates a system that can be utilized by a vehicle (being operated in at least a semi-autonomous) to reduce/mitigate traffic accidents between vehicles and cyclists (e.g., due to car dooring), in accordance with one or more embodiments.

FIGS. 2A and 2B present images illustrating respective car dooring situations, a cyclist being hit by a door and a cyclist avoiding a door.

FIG. 3 is a schematic illustrating a scenario pertaining to car dooring incidents and the mitigation/prevention thereof, according to one or more embodiments.

FIG. 4 is a schematic illustrating a cyclist navigating a bike lane in direction y, while a vehicle is also travelling in direction y, in accordance with one or more embodiments FIG. 4, schematic 400, illustrates an embodiment.

FIGS. 5A and 5B present schematics illustrating detection of movement of a parked vehicle/being parked vehicle, in accordance with an embodiment.

FIGS. 6A and 6B present schematics illustrating determination of a cyclist direction of travel relative to a parking direction of a parked vehicle, in accordance with one or more embodiments presented herein.

FIG. 7 is a schematic illustrating a range of data available to be captured and/or determined regarding motion of a cyclist relative to one or more parked vehicles, per an embodiment.

FIG. 8 presents a schematic illustrating a height of a cyclist being determined to enable determination of the age of cyclist, in accordance with an embodiment.

FIG. 9 presents a schematic illustrating an example scenario where a cyclist brakes/stops in time to prevent colliding with a vehicle door and according action by a passing vehicle, in accordance with an embodiment.

FIG. 10 presents a schematic illustrating an example scenario where a cyclist changes their route to avoid hitting a vehicle door and according action by a passing vehicle, in accordance with an embodiment.

FIG. 11 presents a schematic illustrating an example scenario of a cyclist altering their route to avoid hitting a vehicle door and according action by a passing vehicle, wherein the cyclist is riding in the traffic lane, in accordance with an embodiment.

FIGS. 12A and 12B present images depicting analysis and identification of components comprising a parked vehicle based upon information extracted from an image captured of the vehicle, in accordance with an embodiment.

FIG. 13 illustrates a flow diagram for a computer-implemented methodology for a first vehicle being operated in an at least semi-autonomous manner to mitigate involvement of the first vehicle in a car dooring incident, in accordance with at least one embodiment.

FIG. 14 illustrates a flow diagram for a computer-implemented methodology for detection of a direction a vehicle is facing when parked and/or being parked, relative to a direction being navigated by a cyclist, in accordance with at least one embodiment.

FIG. 15 illustrates a flow diagram for a computer-implemented methodology to determine probability/likelihood of a dooring incident occurring, and responsive action(s), in accordance with at least one embodiment.

FIG. 16 illustrates a flow diagram for a computer-implemented methodology to determine a height of a cyclist and adjust probabilities of a dooring incident and response thereto, in accordance with at least one embodiment.

FIG. 17 is a block diagram illustrating an example computing environment in which the various embodiments described herein can be implemented.

FIG. 18 is a block diagram illustrating an example computing environment with which the disclosed subject matter can interact, in accordance with an embodiment.

FIG. 19 presents TABLE 1900 presenting a summary of SAE J3016 detailing respective functions and features during Levels 0-5 of driving automation (per June 2018).

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting. Further, it is to be appreciated that when information is generated by a first component, the information is available to all of the components across the system. Hence, when a first component/device generates data/information, given all of the components/devices presented herein are either connected directly, or via an intermediary component/device, the data/information is available from the first component to the second component. Accordingly, while there may be no explicit mention of the first component generating data/information and transmitting the data/information to a second component, wherein the data/information is received and acted upon by the second component, it should be taken that the transmission and receipt process has been undertaken.

As used herein, “data” can comprise metadata. Further, ranges A-n are utilized herein to indicate a respective plurality of devices, components, signals etc., where n is any positive integer.

In the various embodiments presented herein, the disclosed subject matter can be directed to utilizing one or more components located on a first vehicle being operated in an at least a partially-autonomous manner, wherein the one or more components can be utilized to reduce traffic accidents between vehicles and cyclists. A first vehicle can utilize various onboard systems and sensors, including one or more computer implemented algorithms (including vision algorithms), to detect a cyclist navigating a road, bicycle lane, and suchlike, whereby the cyclist is cycling proximate to a parked vehicle, with the possibility of a car door being opened into the cyclist's path. Accordingly, the first vehicle can determine whether a dooring incident may occur and take responsive action to prevent the first vehicle from hitting the cyclist as a result of the cyclist's actions to avoid being doored or as a result of being doored.

The first vehicle can utilize the various onboard sensors and systems (e.g., using computer vision algorithms and suchlike) to determine/predict a trajectory of the cyclist and/or the first vehicle being proximate, or soon to be proximate, to the cyclist. In a non-limiting series of scenarios, the first vehicle can (i) determine direction of the cyclist and the direction a parked vehicle is facing, such that, if the car is parked facing towards the cyclist the chance of a dooring incident is reduced compared to (ii) a situation where the car is parked facing in the same direction as the cyclist is travelling.

The first vehicle can be configured to gather information regarding the cyclist such as cyclist speed, cyclist height (e.g., adult, child), time until the cyclist will be at the vehicle with the door potentially ajar. The first vehicle can be further configured to determine a dimension(s) of the parked vehicle, an approximate location of a door(s) on the parked vehicle, e.g., based on an approximate distance from the front of the vehicle, rear of the vehicle, location of wheels/wheel wells, and suchlike, as well as a make and model of the parked vehicle based on such information as (a) the license plate of the parked vehicle, (b) make/model identifiers on the parked vehicle, and the like.

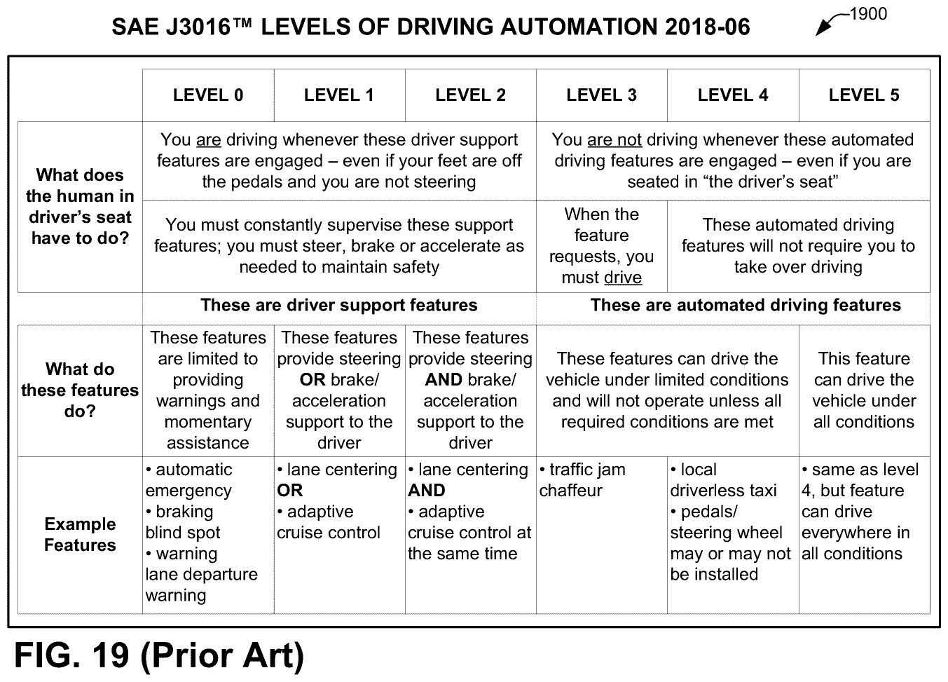

Regarding the phrase “autonomous” operation, to enable the level of sophistication of operation of a vehicle to be defined across the industry by both suppliers and policymakers, standards are available to define the level of autonomous operation. For example, the International Standard J3016 Taxonomy and Definitions for Terms Related to Driving Automation Systems for On-Road Motor Vehicles has been developed by the Society of Automotive Engineers (SAE) and defines six levels of operation of a driving automation system(s) that performs part or all of the dynamic driving task (DDT) on a sustained basis. The six levels of definitions provided in SAE J3016 range from no driving automation (Level 0) to full driving automation (Level 5), in the context of vehicles and their operation on roadways. Levels 0-5 of SAE J3016 are summarized below and further presented in FIG. 19, Table 1900.

Level 0 (No Driving Automation): At Level 0, the vehicle is manually controlled with the automated control system (ACS) having no system capability, the driver provides the DDT regarding steering, braking, acceleration, negotiating traffic, and suchlike. One or more systems may be in place to help the driver, such as an emergency braking system (EBS), but given the EBS technically doesn't drive the vehicle, it does not qualify as automation. The majority of vehicles in current operation are Level 0 automation.

Level 1 (Driver Assistance/Driver Assisted Operation): This is the lowest level of automation. The vehicle features a single automated system for driver assistance, such as steering or acceleration (cruise control) but not both simultaneously. An example of a Level 1 system is adaptive cruise control (ACC), where the vehicle can be maintained at a safe distance behind a lead vehicle (e.g., operating in front of the vehicle operating with Level 1 automation) with the driver performing all other aspects of driving and has full responsibility for monitoring the road and taking over if the assistance system fails to act appropriately.

Level 2 (Partial Driving Automation/Partially Autonomous Operation): The vehicle can (e.g., via an advanced driver assistance system (ADAS)) steer, accelerate, and brake in certain circumstances, however, automation falls short of self-driving as tactical maneuvers such as responding to traffic signals or changing lanes can mainly be controlled by the driver, as does scanning for hazards, with the driver having the ability to take control of the vehicle at any time.

Level 3 (Conditional Driving Automation/Conditionally Autonomous Operation): The vehicle can control numerous aspects of operation (e.g., steering, acceleration, and suchlike), e.g., via monitoring the operational environment, but operation of the vehicle has human override. For example, the autonomous system can prompt a driver to intervene when a scenario is encountered that the onboard system cannot navigate (e.g., with an acceptable level of operational safety), accordingly, the driver must be available to take over operation of the vehicle at any time.

Level 4 (High Driving Automation/High Driving Operation): advancing on from Level 3 operation, while under Level 3 operation the driver must be available, with Level 4, the vehicle can operate without human input or oversight but only under select conditions defined by factors such as road type, geographic area, environments limiting top speed (e.g., urban environments), wherein such limited operation is also known as “geofencing”. Under Level 4 operation, a human (e.g., driver) still has the option to manually override automated operation of the vehicle.

Level 5 (Full Driving Automation/Full Driving Operation): Level 5 vehicles do not require human attention for operation, with operation available on any road and/or any road condition that a human driver can navigate (or even beyond the navigation/driving capabilities of a human). Further, operation under Level 5 is not constrained by the geofencing limitations of operation under Level 4. In an embodiment, Level 5 vehicles may not even have steering wheels or acceleration/brake pedals. In an example of use, a destination is entered for the vehicle (e.g., by a passenger, by a supply manager where the vehicle is a delivery vehicle, and suchlike), wherein the vehicle self-controls navigation and operation of the vehicle to the destination.

To clarify, operations under levels 0-2 can require human interaction at all stages or some stages of a journey by a vehicle to a destination. Operations under levels 3-5 do not require human interaction to navigate the vehicle (except for under level 3 where the driver is required to take control in response to the vehicle not being able to safely navigate a road condition).

As referenced herein, DDT relates to various functions of operating a vehicle. DDT is concerned with the operational function(s) and tactical function(s) of vehicle operation, but may not be concerned with the strategic function. Operational function is concerned with controlling the vehicle motion, e.g., steering (lateral motion), and braking/acceleration (longitudinal motion). Tactical function (aka, object and event detection and response (OEDR)) relates to the navigational choices made during a journey to achieve the destination regarding detecting and responding to events and/or objects as needed, e.g., overtake vehicle ahead, take the next exit, follow the detour, and suchlike. Strategic function is concerned with the vehicle destination and the best way to get there, e.g., destination and way point planning. Regarding operational function, a Level 1 vehicle under SAE J3016 controls steering or braking/acceleration, while a Level 2 vehicle must control both steering and braking/acceleration. Autonomous operation of vehicles at Levels 3, 4, and 5 under SAE J3016 involves the vehicle having full control of the operational function and the tactical function. Level 2 operation may involve full control of the operational function and tactical function but the driver is available to take control of the tactical function.

Accordingly, the term “autonomous” as used herein regarding operation of a vehicle with or without a human available to assist the vehicle in self-operation during navigation to a destination, can relate to any of Levels 1-5. In an embodiment, for example, the terms “autonomous operation” or “autonomously” can relate to a vehicle operating at least with Level 2 operation, e.g., a minimum level of operation is Level 2: partially autonomous operation, per SAE J3016. Hence, while Level 2, partially autonomous operation, may be a minimum level of operation, higher levels of operation, e.g., Levels 3-5, are encompassed in operation of the vehicle at Level 2 operation. Similarly, a minimum Level 3 operation encompasses Levels 4-5 operation, and minimum Level 4 operation encompasses operation under Level 5 under SAE J3016.

It is to be appreciated that while the various embodiments presented herein are directed towards to one or more vehicles (e.g., vehicle 102) operating in an autonomous manner (e.g., as an AV), the various embodiments presented herein are not so limited and can be implemented with a group of vehicles operating in any of an autonomous manner (e.g., Level 5 of SAE J3016), a partially autonomous manner (e.g., Level 1 of SAE J3016 or higher), or in a non-autonomous manner (e.g., Level 0 of SAE J3016). For example, a first vehicle can be operating in an autonomous manner (e.g., any of Levels 3-5), a partially autonomous manner (e.g., any of levels 1-2), or in a non-autonomous manner (e.g., Level 0), while a second vehicle (e.g., vehicle 125), a lead vehicle behind which the first vehicle is driving, can also be operating in any of an autonomous manner, a partially autonomous manner, or in a non-autonomous manner.

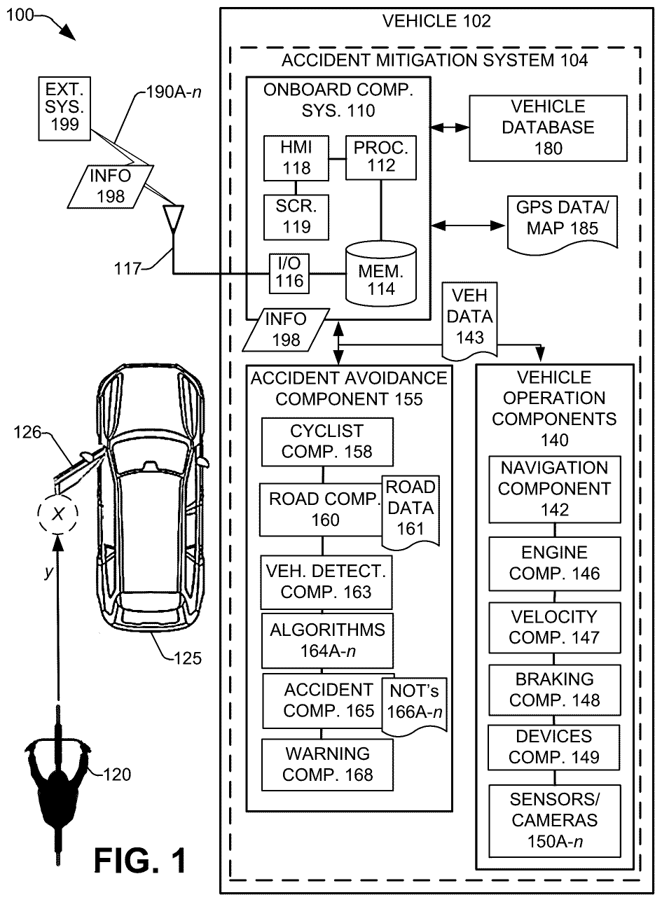

Turning now to the drawings, FIG. 1 illustrates a system 100 that can be utilized by an AV to reduce traffic accidents between vehicles and cyclists, in accordance with one or more embodiments. System 100 comprises a vehicle 102 with an accident mitigation system 104 located thereon, wherein vehicle 102 can be an AV operating in at least a partially autonomous manner. The accident mitigation system 104 can comprise various devices/components, such as an onboard computer system (OCS) 110, wherein the OCS 110 can be a vehicle control unit (VCU). The OCS 110 can be utilized to provide overall operational control and/or operation of the AV.

In an embodiment, the OCS 110 can be configured to operate/control/monitor various vehicle operations, wherein the various operations can be controlled by one or more vehicle operation components 140 communicatively coupled to the OCS 110. The various vehicle operation components 140 can include, in a non-limiting list, any of: a navigation component 142 configured to navigate vehicle 102 along a road as well as to control steering of the vehicle 102; an engine component 146 configured to control operation, e.g., start/stop, of an engine configured to propel the vehicle 102; a velocity component 147 configured to determine any of a speed, a direction, a velocity of the vehicle 102; a braking component 148 configured to slow down or stop the vehicle 102; and/or a devices component 149 configured to control operation of any onboard devices suitable to get the attention of a cyclist (e.g., a cyclist 120), driver of another vehicle (e.g., vehicle 125), and the like. The onboard devices can include a device configured to generate an audible signal (e.g., a car horn on the vehicle 102, an audible message regarding “cyclist approaching”, and suchlike) and/or a visual signal (e.g., hazard lights (e.g., hazard lights 1050), headlights on the vehicle 102). In an embodiment, the vehicle operation component 140 and subcomponents can provide operational data/information 143 to the OCS 110 and other components incorporated into the accident mitigation system 104, for example, velocity, speed, and/or direction of vehicle 102.

The vehicle operation components 140 can further comprise various sensors and/or cameras 150A-n configured to monitor operation of vehicle 102 and further obtain imagery and other information regarding an environment/surroundings the vehicle 102 is operating in. The sensors/cameras 150A-n can include any suitable detection/measuring device, including cameras, optical sensors, laser sensors, Light Detection and Ranging (LiDAR) sensors, sonar sensors, audiovisual sensors, perception sensors, road lane sensors, motion detectors, velocity sensors, and the like, as employed in such applications as simultaneous localization and mapping (SLAM), and other computer-based technologies and methods utilized to determine an environment being navigated by vehicle 102 and the location of the vehicle 102 within the environment (e.g., location mapping). Digital images, data, and the like generated by sensors/cameras 150A-n (e.g., captured from a field of view and/or reflected signals) can be analyzed by algorithms 164A-n to identify respective features of interest such as a cyclist 120, another vehicle 125, lane markings (e.g., lane markers 240 and 250 further described herein), etc. In an embodiment, a camera 150A can capture visual data from the environment/surroundings, while a sensor 150B can operate based upon transmission of transmission and reflection of a signal (e.g., an infra-red (IR) signal), per field of view/detection beam 320, as further described herein. It is to be appreciated that while the term beam and according shape (e.g., beam 320) are utilized herein, the term beam can also be interpreted as field-of-view of a camera or suchlike.

As shown, accident mitigation system 104 can further include an accident avoidance component (AAC) 155, wherein the AAC 155 can further comprise various components that can be utilized to mitigate traffic accidents between vehicles and cyclists. As shown in FIG. 1, the AAC 155 can be communicatively coupled to the OCS 110, the vehicle operation components 140, and other components located on board vehicle 102.

A cyclist component 158 can be included in the AAC 155, wherein the cyclist component 158 can be configured to monitor and identify (aka determine/predict/infer) any of motion, a current and future location, a trajectory of motion, and suchlike, of the cyclist 120. The cyclist component 158 can be configured to receive information/data from the various on-board sensors and cameras 150A-n, as well as provided by algorithms 164A-n, and the like.

A road component 160 can be included in the AAC 155, wherein the road component 160 can analyze information (e.g., digital images, data) from various onboard sensors and cameras 150A-n to identify respective lane markings and suchlike, from which the road component 160 can generate road data 161 regarding a road being navigated by any of vehicle 102, cyclist 120, vehicle 125. Accordingly, the road data 161 can include information regarding the width of the road, number of lanes forming the road, width of the lane(s), presence of a bike lane, width of a bicycle lane, presence of a parking lane, width of a parking lane, and the like. The road component 160 can further receive information from a GPS data/map system 185, wherein the GPS data/map system 185 can provide information to supplement the road data 161 (e.g., number of lanes forming the road, width of the road, width of a lane(s), the road has a parking lane ahead (such as parking lane 230, further described herein) and the like). Further, the road component 160 can receive road information from an external system 199 (e.g., a remote GPS system) providing further information regarding the road being navigated, which can further supplement road data 161.

The AAC 155 can further include a vehicle detection component 163 which can be configured to identify and monitor operation (e.g., location, motion, direction) of another vehicle, e.g., vehicle 125 parked facing direction y (per FIG. 1), that was also navigating the road being navigated by the vehicle 102, but is now parked, however, a scenario can arise where the vehicle 125 maybe being parked in or driven out of the parking space. The vehicle detection component 163 can be configured to receive information regarding the vehicle 125 from data generated by the sensors/cameras 150A-n, wherein the information can be one or more dimensions of vehicle 125, direction the vehicle 125 is facing, location of a door on the vehicle 125 and whether it is being opened/about to be opened, make/model of vehicle 125, license plate of vehicle 125, and suchlike. Further, the vehicle detection component 163 can access a vehicle database 180 (e.g., located onboard vehicle 102) which can provide make/model information regarding vehicle 125, as further discussed herein. In another embodiment, the vehicle detection component 163 can be configured to determine whether the driver of vehicle 125 is engaged with their surroundings such as looking in a rearview mirror in the direction of cyclist 120, and such like.

The AAC 155 can further comprise various algorithms 164A-n respectively configured/trained to determine information, make predictions, etc., regarding any of the road being navigated, a velocity of a cyclist 120 navigating a road, a velocity of the vehicle 102, movement and/or trajectory of another vehicle (e.g., vehicle 125) regarding parked stationary or being driven, a time it will potentially take a cyclist 120 to be within dooring distance of the vehicle 125, a position of another vehicle 125, a trajectory of the cyclist 120, a potential intersection (marked x on FIG. 1) of the trajectory of the cyclist 120 with the car door 126 of vehicle 125, and suchlike. Algorithms 164A-n can include a computer vision algorithm(s), a digital imagery algorithm(s), position prediction, velocity prediction, direction prediction, and suchlike, to enable the respective determinations, predictions, etc., per the various embodiments presented herein.

An accident component 165 can be further included in the AAC 155, wherein the accident component 165 can be configured to determine likelihood/probability of cyclist 120 colliding with door 126, a likelihood of collision/dooring, a location of collision (e.g., at location x on FIG. 1), and suchlike. As shown in FIG. 1, the accident component 165 can be configured to analyze the wealth of information generated regarding cyclist 120 (e.g., their speed and motion, trajectory y, age/distractedness, and suchlike.) and the vehicle 125 (e.g., speed and motion, trajectory y, negligence/distractedness of the driver, and suchlike). The accident component 165 can be configured to generate one or more notifications 166A-n regarding a respective likelihood of an accident occurring between the cyclist 120 and the vehicle 125/door 126.

The AAC 155 can further include a warning component 168. The warning component 168 can be configured to operate in conjunction with the accident component 165, wherein the warning component 168 can receive a notification 166A from the accident component 165 that a high likelihood of collision exists between the cyclist 120 and the vehicle 125/door 126. In response to receiving the notification 166A, the warning component 168 can interact with the devices component 149 to initiate operation of the headlights, hazard lights, car horn, etc., to obtain the attention of the cyclist 120 and/or driver of vehicle 125.

It is to be appreciated that while FIG. 1 presents accident component 165 generating/transmitting notifications 166A-n, any of the components included in the accident mitigation system 104 can generate and transmit notifications 166A-n to one or more other components included in the accident mitigation system 104. Further, the notifications 166A-n can include information beyond notifications, wherein the notifications 166A-n can include instructions (e.g., a first component instructs a second component to perform an action), warnings, and suchlike.

Accident mitigation system 104 can also include a vehicle database 180, wherein the vehicle database 180 can comprise various vehicle identifiers such as makes/models, a list of license plates and vehicles they are registered to, and suchlike, to enable determination of a vehicle 125 operating in the locality of vehicle 102 (e.g., by the vehicle detection component 163), vehicle dimensions, door placement, etc.

As shown in FIG. 1, the OCS 110 can further include a processor 112 and a memory 114, wherein the processor 112 can execute the various computer-executable components, functions, operations, etc., presented herein. The memory 114 can be utilized to store the various computer-executable components, functions, code, etc., as well as road data 161, algorithms 164A-n, notifications 166A-n, information (e.g., motion, trajectory) regarding cyclist 120, information (e.g., location, parked direction, motion, trajectory, door 126 location, door opening) regarding vehicle 125, and suchlike (as further described herein). In an embodiment, the vehicle operation components 140 can form a standalone component communicatively coupled to the OCS 110, and while not shown, the vehicle operation components 140 can operate in conjunction with a processor (e.g., functionally comparable to processor 112) and a memory (e.g., functionally comparable to memory 114) to enable navigation, steering, braking/acceleration, etc., of vehicle 102 to a destination/collision avoidance. In another embodiment, the vehicle operation components 140 can operate in conjunction with the processor 112 and memory 114 of the OCS 110, wherein the various control functions (e.g., navigation, steering, braking/acceleration) can be controlled by the OCS 110. Similarly, the AAC 155 can form a standalone component communicatively coupled to the OCS 110, and while not shown, the AAC 155 can operate in conjunction with a processor (e.g., functionally comparable to processor 112) and a memory (e.g., functionally comparable to memory 114) to enable accident detection, e.g., during operation of vehicle 102. In another embodiment, the AAC 155 can operate in conjunction with the processor 112 and memory 114 of the OCS 110, wherein the various accident detection functions can be controlled by the OCS 110. In a further embodiment, the OCS 110, vehicle operation components 140, and the AAC 155 (and respective sub-components) can operate using a common processor (e.g., processor 112) and memory (e.g., memory 114).

As further shown, the OCS 110 can include an input/output (I/O) component 116, wherein the I/O component 116 can be a transceiver configured to enable transmission/receipt of information 198 (e.g., a warning notification 166A-n, road data 161, and the like) between the OCS 110 and any external system(s) (e.g., external system 199), e.g., an onboard system of vehicle 125, a cellphone, a GPS data system, a computer-based system, and suchlike. I/O component 116 can be communicatively coupled, via an antenna 117, to the remotely located devices and systems (e.g., external system 199). Transmission of data and information between the vehicle 102 (e.g., via antenna 117 and I/O component 116) and the remotely located devices and systems can be via the signals 190A-n. Any suitable technology can be utilized to enable the various embodiments presented herein, regarding transmission and receiving of signals 190A-n. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

In an embodiment, the OCS 110 can further include a human-machine interface (HMI) 118 (e.g., a display, a graphical-user interface (GUI)) which can be configured to present various information including imagery of/information regarding cyclist 120, vehicle 125, door 126, the road, alarms, warnings, information received from onboard and external systems and devices, etc., per the various embodiments presented herein. The HMI 118 can include an interactive display 119 to present the various information via various screens presented thereon, and further configured to facilitate input of information/settings/etc., regarding operation of the vehicle 102. In an embodiment, in the event that vehicle 102 is being operated in a non-autonomous manner (e.g., Level 0 of SAE J3016), operation of the warning component 168 and notifications 166A-n can be utilized to present a warning on the HMI 118 and screen 119 to notify the driver of vehicle 102 of the possible collision between the cyclist 120 and the vehicle 125.

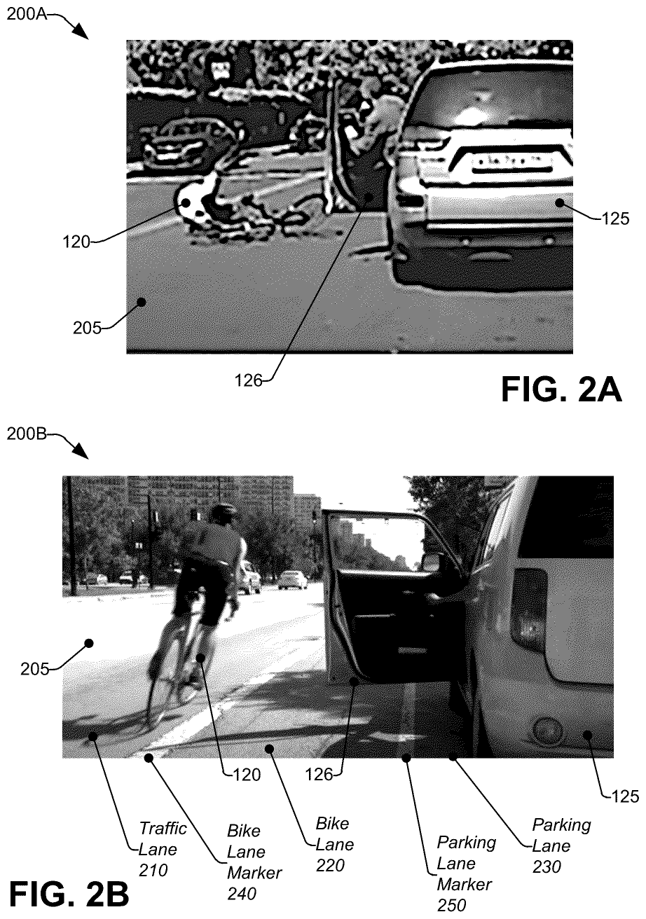

Turning to FIGS. 2A and 2B, images 200A and 200B illustrate respective situations involving a dooring-based events. FIG. 2A illustrates a situation where a cyclist 120 is falling into road 205 after colliding with an open door 126 of vehicle 125 that was opened in the cyclist's path. FIG. 2B illustrates a situation where a cyclist 120 is avoiding a vehicle door 126 being opened by a driver/occupant of vehicle 125. As illustrated, vehicle 125 is parked in the parking lane 230, and the cyclist 120 was initially riding along the bike lane 220, wherein the bike lane 220 and the parking lane 230 are present on the road 205 and are separated by the parking lane marker 250 (e.g., a painted line on the road surface that extends along the length of the parking lane 230. As further illustrated, to avoid colliding with the door 126, the cyclist 120 has moved out of the bike lane 220 and into the traffic lane 210, wherein the bike lane 220 and the traffic lane 210 are present on the road 205 and are separated by the bike lane marker 240 (e.g., a painted line on the road surface that extends along the length of the bike lane 220). Once the door 126 has been avoided, the cyclist 120 can return to the bike lane 220 to continue their journey.

In an embodiment, the various lane markings (e.g., bike lane marker 240 and parking lane marker 250 depicted in FIG. 2B) and kerb/curb structures (not shown) can be marked on a road surface utilizing lane markings such as white and/or yellow painted stripes, where the stripes can be a continuous line or a broken/dashed pattern. Lane markings can also be indicated by other techniques, such as white stones, rumble strips, reflective beads or surfaces located on or in a road surface, such as reflective studs colloquially termed “cat's eyes”, and such like. As mentioned previously, the road component 160 (e.g., in conjunction with onboard sensors/cameras 150A-n, a computer vision algorithm 164A, and suchlike) can be configured to compile road data 161 regarding the presence of the lane markings 240 and 250, kerb/curb structures, and suchlike, as well as the presence/motion of the cyclist 120, the location/movement of the vehicle 125, and the location of the door 126 and whether it is being opened.

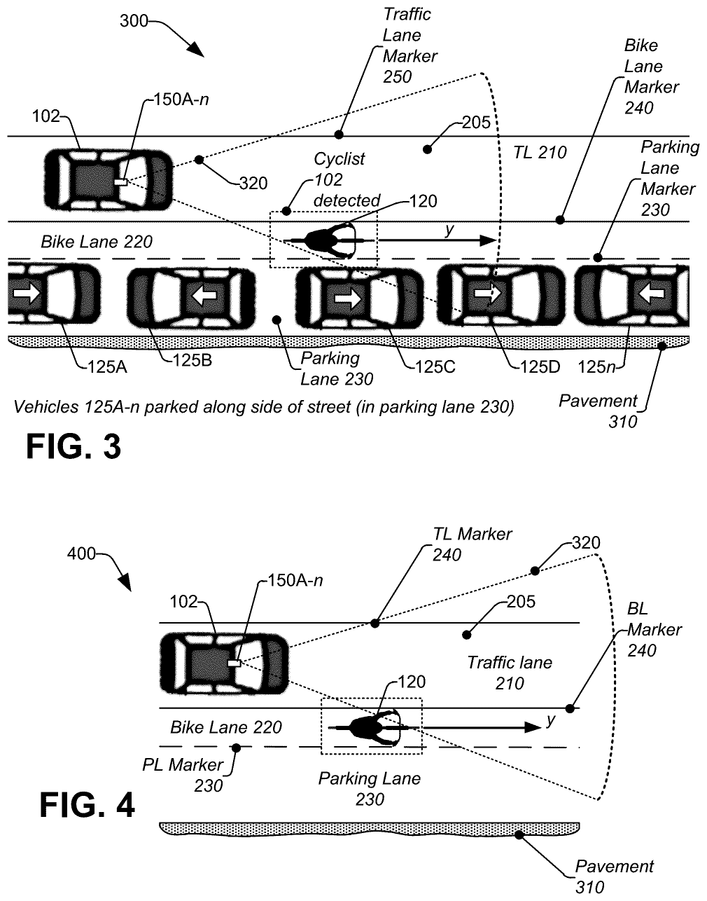

FIG. 3, schematic 300, illustrates a scenario of application for the various embodiments presented herein regarding mitigating/preventing car dooring incidents. FIG. 3 illustrates a road 205 comprising three lanes, traffic lane 210, bike lane 220, and a parking lane 230, wherein a group of vehicles 125A-n are respectively parked in the parking lane 230 between a pavement/sidewalk 310 and the parking lane marker 250. A cyclist 120 is cycling along the bike lane 220 in direction y, while a vehicle 102 is driving in the traffic lane 210. As previously mentioned, the vehicle 102 can be operating non-autonomously, semi-autonomously, or in full autonomous mode. As shown, the onboard cameras/sensors 150A-n are active and determining any of the presence/motion of the cyclist 120 relative to the road 205, the location/movement of the vehicle 125, the location of the door 126 and whether it is being opened, e.g., based upon light detection (e.g., by a camera 150A), IR return signaling (e.g., by an IR sensor 150B) and suchlike, as indicated by field of view/detection beam 320. While the possibility exists that all of the vehicles 125A-n are parked facing the same direction (e.g., in direction y), it is possible that some vehicles are facing in another direction, e.g., vehicles 125B and 125n are parked facing the opposite direction of vehicles 125A, 125C, and 125D (as shown by the arrow associated with each vehicle). As further described, the accident mitigation system 104 can detect and determine the respective parked direction of the vehicle 125A-n and a risk, as a function of the parked directions, of a cyclist 120 being doored.

FIG. 4, schematic 400, illustrates an embodiment with a cyclist 120 navigating a bike lane 220 in direction y, while a vehicle 102 is also travelling in direction y, in accordance with an embodiment. As shown, the onboard sensors 150A-n are active, with cyclist 120 being detected by field of view/detection beam 320. The accident mitigation system 104 (e.g., accident component 165 operating in conjunction with the cyclist component 158, the road component 160, the vehicle detection component 163, algorithms 164A-n, data from sensors 150A-n, and suchlike) can be configured to (i) determine the presence/motion of the cyclist 120 in the bike lane 220, and (ii) further determine that no vehicles (e.g., no vehicles 125A-n) are present in the parking lane 230. Accordingly, the accident component 165 can make an assessment that given the lack of presence of any vehicles 125A-n being proximate to the cyclist 120 in the immediate future, there is no risk to the cyclist 120 of the cyclist being doored (per TABLE 1 herein). Accordingly, in an embodiment, in response to determining the lack of risk of the cyclist being doored, the accident component 165 can be configured to generate a notification 166A that there is currently no risk of a dooring event occurring and, accordingly, the various components operating to control navigation of the vehicle 102 (e.g., OCS 110, the various components 142, 146, 147, 148, and 149) can continue to operate in a normal manner, as there is no requirement to slow down or change navigation of vehicle 102 (e.g., to avoid the cyclist 120). Accordingly, in another embodiment, in response to determining the lack of risk of the cyclist being doored, the accident component 165 can be configured to not generate a notification 166A regarding a dooring event, wherein the various components operating to control navigation of the vehicle 102 can operate as normal (e.g., do not slow down or alter the direction of vehicle 102).

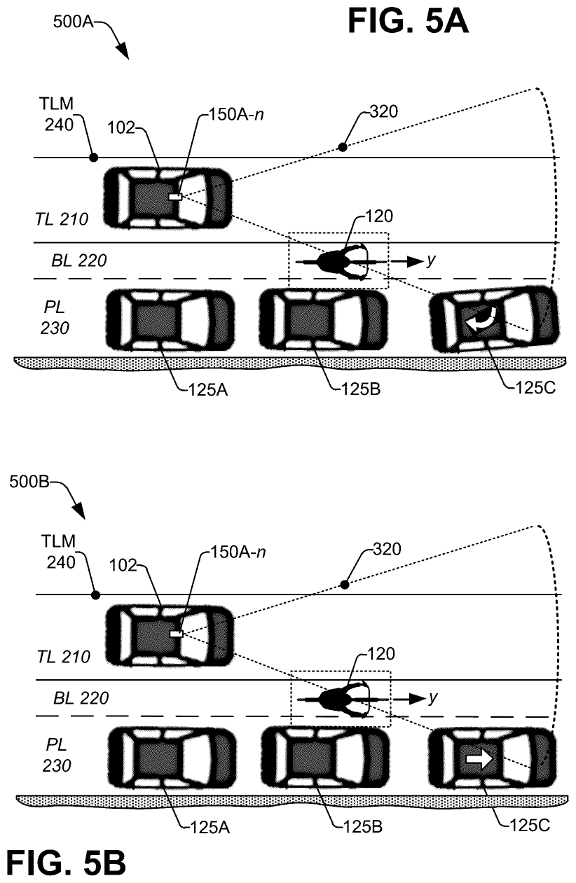

FIGS. 5A and 5B, schematics 500A and 500B, illustrate an embodiment with a cyclist 120 riding a bike lane 220 in direction y, while vehicle 102 is also travelling in direction y proximate to the cyclist 120. As shown, the onboard sensors 150A-n are active, with cyclist 120 being detected by field of view/detection beam 320, and also various vehicles 125A-n parked in the parking lane 230. As shown, a vehicle 125C is being operated to maneuver vehicle 125C (e.g., a parallel parking maneuver) into a parking space in the parking lane 230, whereby the vehicle detection component 163 can be configured to determine (e.g., based on data generated by sensors 150A-n and field of view/detection beam 320) that the vehicle 125C is currently in motion as it is being parked (reversing into the parking space per FIG. 5A, and pulling forward as a final maneuver per FIG. 5B). In an embodiment, based on a determination that the vehicle 125B is currently in motion (per FIGS. 5A and 5B), the accident component 165 can be configured to make a determination that there is no risk of the cyclist being doored. Accordingly, the accident component 165 can be configured to generate a notification 166B that there is currently no risk of a dooring event occurring and, accordingly, the various components operating to control navigation of the vehicle 102 (e.g., OCS 110, the various components 142, 146, 148, and 149) can continue to operate in a normal manner, as there is no requirement to slow down or change navigation of vehicle 102 (e.g., to avoid the cyclist 120). Accordingly, in another embodiment, in response to determining the lack of risk of the cyclist being doored, the accident component 165 can be configured to not generate a notification 166A regarding a dooring event, wherein the various components operating to control navigation of the vehicle 102 can operate as normal (e.g., do not slow down or alter the direction of vehicle 102).

However, in a scenario where the vehicle 125C has performed the parking maneuver while the cyclist 120 is cycling towards vehicle 125C, the accident component 165 can be configured to determine that the possibility of the cyclist 120 being doored by the opening of vehicle door 126 exists. Accordingly, the accident component 165 can be configured to generate a notification 166B that a risk currently exists of a dooring event occurring and, accordingly, the various components operating to control navigation of the vehicle 102 (e.g., OCS 110, the various components 142, 146, 148, and 149) may have to operate to mitigate the change of a dooring event occurring, as further described, e.g., reduce speed of/stop vehicle 102, change direction of travel of vehicle 102 (e.g., to avoid the cyclist 120, particularly if the cyclist 120 falls over after the dooring event).

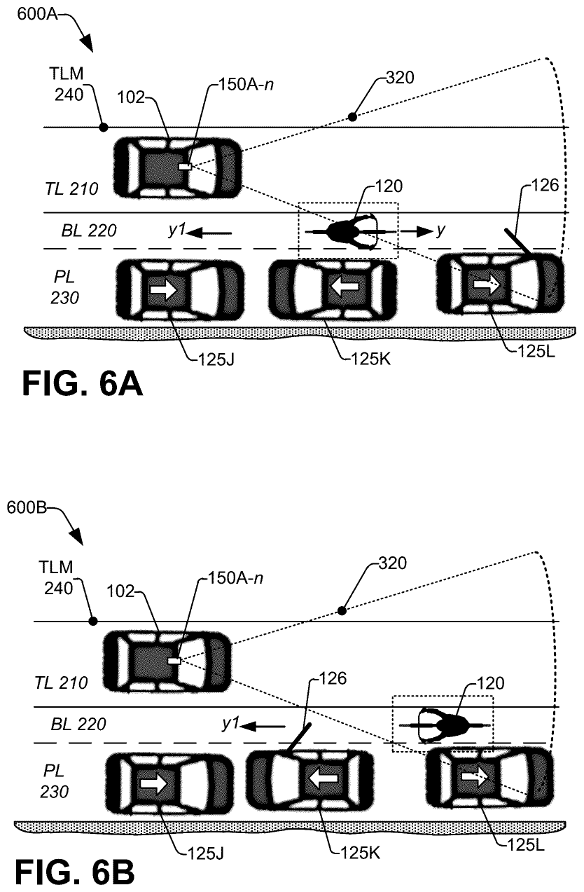

FIGS. 6A and 6B, schematics 600A and 600B, illustrate embodiments regarding vehicle 102 determining (a) direction of travel of a cyclist 120 and (b) direction of parking of vehicles 125A-n with regard to (c) determining a risk of a dooring event occurring, per one or more embodiments presented herein. As shown in FIG. 6A, cyclist 120 is navigating a bike lane 220 in direction y, with vehicle 102 also travelling in direction y proximate to the cyclist 120, such that cyclist 120 has been detected by the field of view/detection beam 320. The detection beam has also identified a direction in which the respective vehicles 125J, 125K, and 125L are parked, wherein vehicles 125J and 125L are parked facing direction y, (as indicated by the arrow icons) while vehicle 125K is parked facing direction y1. Accordingly, based on the image data/signals received at sensors 150A-n, the vehicle detection component 163 (e.g., in conjunction with algorithms 164A-n), can be configured to determine whether vehicle 125L is moving or not. In the event of a determination by vehicle detection component 163, that the vehicle is parked facing direction y, the accident component 165 can be configured to determine (e.g., based on parking data provided by the vehicle detection component 163) that (a) vehicle 125L is stationary (e.g., parked) and facing direction y and (b) cyclist 120 is travelling in direction y, the accident component 165 can be configured to determine that there is a risk of a dooring incident occurring at vehicle 125L.

FIG. 6B presents an alternative scenario where cyclist 120 is cycling in direction y1, which is the direction in which vehicle 125K is parked. Accordingly, given that vehicles 125J and 125L are parked facing direction y, these vehicles can be deemed (e.g., by accident component 165) to present minimal risk of dooring (e.g., owing to the driver of the respective vehicle seeing cyclist 120 approaching). However, owing to the parking direction of vehicle 125, the accident component 165 can be configured to determine that there is a risk of a dooring incident occurring at vehicle 125K.

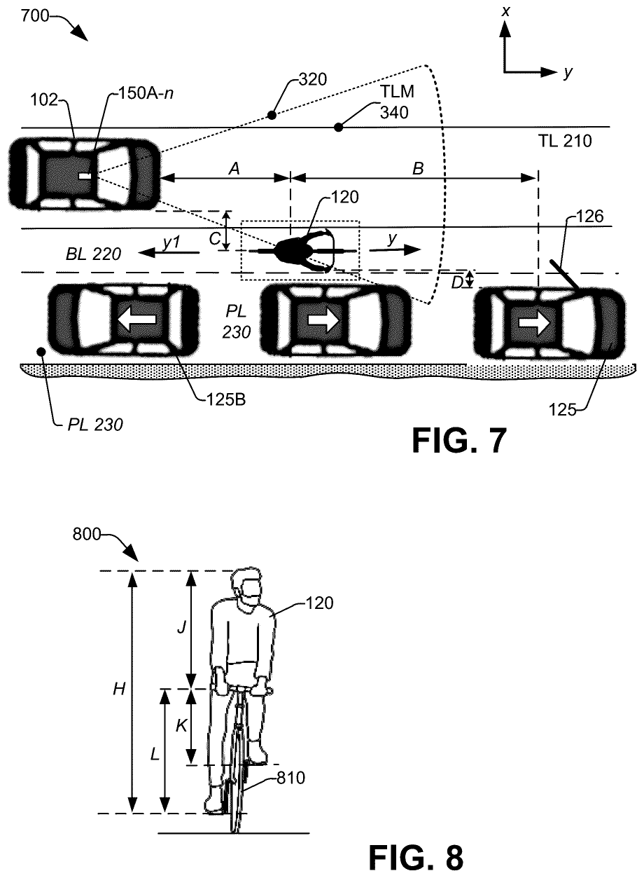

FIG. 7, schematic 700, illustrates various data that can be captured and/or determined regarding motion of a cyclist relative to one or more parked vehicles, per an embodiment. As shown, the following dimensions/parameters can be determined:
y or y1=a direction of travel of the cyclist 120.
VC=velocity of travel of the cyclist 120 (wherein the velocity can be a vector component that includes the direction of travel).
VV=velocity of the vehicle 102.
A=distance from vehicle 102 to the cyclist 120.
B=distance of travel of the cyclist 120 to the vehicle 125 (and door 126).
C=distance from vehicle 102 to cyclist 120 (e.g., in direction x).
D=distance from cyclist 120 to vehicle 125 and door 126 (e.g., in direction x).

By knowing various parameters/values y/y1, VC. VV. A, B, C, and D, vehicle 102 (e.g., accident component 165) can determine any of the time required for the cyclist 120 and/or the vehicle 102 to arrive at dooring position X (per FIG. 1), and accordingly, whether the vehicle 102 should slow down/stop to (a) avoid the cyclist 120 (e.g., in the event of the cyclist 120 changes lanes to navigate around the door 126), or (b) the cyclist 120 falls into the path of travel of the vehicle 102 as a result of a dooring incident occurring. The smaller the respective values of A, B, C, D, in view of VC and VV, the less time the cyclist 120 has to respond to/avoid a dooring incident, and also, the less time the vehicle 102 has to avoid cyclist 120 in the event of a dooring incident occurring (e.g., cyclist 120 falls into path of vehicle 102, cyclist 120 navigates into the path of the vehicle 102 to avoid a dooring incident).

FIG. 8, schematic 800, illustrates height of a cyclist being determined to enable determination of the age of cyclist, in accordance with an embodiment. As show in FIG. 8, the cyclist component 158 can be configured to determine the height of cyclist 120, and based thereon, can further determine the approximate age of the cyclist 120, e.g., is cyclist 120 an adult or a child? Based on signals in field of view/detection beam 320 (e.g., as received by sensors 150A-n and processed by algorithms 164A-n) the cyclist component 158 can determine the following:
J=distance from saddle of bicycle 810 being ridden to head/helmet of the cyclist 120.
K=distance from saddle of bicycle 810 being ridden by cyclist 120 to the highest pedal point of the bicycle.
L=distance from saddle of bicycle 810 being ridden by cyclist 120 to the lowest pedal point of the bicycle.
H=J+L=height of cyclist 120, wherein the measurements generated by the cyclist component 158 can take into account the poise of the cyclist 120 (e.g., algorithms 164A-n can include a body pose estimator) while riding the bicycle 810.

In the event of determining, for example, H≤150 cm (60″), the cyclist component 158 can be configured to consider cyclist 120 as being a child. In the event of determining the H>150 cm, the cyclist component 158 can be configured to consider cyclist 120 as being an adult. Any value can be predefined for H in the cyclist component 158. Accordingly, in the event of the cyclist 120 being determined to be a child, the relative levels of safe, moderately safe/caution, and dangerous (per TABLE 1) can be further tightened to account for the distractedness/vulnerability of the child.

TABLE 1
RELATIVE PROBABILITIES OF (A) A CYCLIST BEING
INVOLVED IN A DOORING INCIDENT AND (B) A VEHICLE
BEING IN DANGEROUS PROXIMITY OF THE CYCLIST IN
THE EVENT OF A DOORING INCIDENT OCCURRING.

| | Time | Time for | |
|---|---|---|---|
| | for | Vehicle 102 | |
| | cyclist | to reach | Onboard Assessment (e.g., |
| | 120 to | cyclist 120 | by accident component |
| | reach | in event | 165 of vehicle 102) |
| | door | of a dooring | Rating and |
| | 126 | incident | Probability/Assessment |
| A | ≥5 secs | ≥5 secs | SAFE: Cyclist (e.g., cyclist 120) |
| | | | likely has enough time to respond |
| | | | to a door (e.g., door 126) |
| | | | being opened ahead. |
| | | | E.g., probability is <10% chance |
| | | | of dooring incident occurring. |
| B | 3-5 secs | 3-5 secs | NOT SO SAFE/MODERATE |
| | | | RISK: increased probability that a |
| | | | dooring event could occur - risk to |
| | | | cyclist (e.g., cyclist 120) and |
| | | | also riskof vehicle (e.g., |
| | | | vehicle 102) colliding with the cyclist. |
| | | | E.g., probability is >50% chance |
| | | | dooring incident occurs. |
| C | <3 secs | <3 secs | DANGEROUS: |
| | | | (a) high probability of a dooring |
| | | | event occurring; |
| | | | (b)high probability of vehicle being |
| | | | close proximity of the cyclist in event |
| | | | of a dooring occurring. |
| | | | E.g., probability is >85% chance of |
| | | | dooring incident occurs. |

TABLE 1 presents example probability thresholds that can be utilized to determine the relative probability/likelihood of a dooring incident occurring and a rating applied to the respective probability/likelihood, e.g., by accident component 165. In response to a determination that the cyclist 120 is more than 5 seconds away from being proximate to door 126, the accident component 165 can assign a rating of safe, whereby the cyclist 120 is deemed to have sufficient time to avoid opening of door 126. Further, in response to a determination that the vehicle 102 is more than 5 seconds away from cyclist 120 (e.g., when cyclist 120 will be proximate to door 126), the accident component 165 can assign a rating of safe, whereby the cyclist 120 is deemed to have sufficient time to avoid opening of door 126. In response to a determination that the cyclist 120 is between 3 to 5 seconds away from being proximate to door 126, the accident component 165 can assign a rating of moderately safe/caution, whereby there is increased likelihood of cyclist 120 being involved in a dooring incident due to the opening of door 126. Further, in response to a determination that the vehicle 102 is 3-5 seconds away from cyclist 120 (e.g., when cyclist 120 will be proximate to door 126), the accident component 165 can assign also assign a rating of moderately safe/caution, whereby the cyclist 120 is deemed to have sufficient time to avoid opening of door 126. In response to a further determination that the cyclist 120 is less than 3 seconds away from being proximate to door 126, the accident component 165 can assign a rating of dangerous, whereby there is a high likelihood of cyclist 120 being involved in a dooring incident due to the opening of door 126. Further, in response to a determination that vehicle 102 is less than 3 seconds away from cyclist 120 (e.g., when cyclist 120 will be proximate to door 126), the accident component 165 can assign also assign a rating of dangerous, whereby the cyclist 120 is deemed to have sufficient time to avoid opening of door 126.

Obviously, the respective ratings, timings, distances, etc., are arbitrary thresholds and can be configured/predefined in accident component 165 to any desired value. As used herein, the terms “infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In this particular embodiment, the accident component 165 and the associated algorithms 164A-n can include a machine learning and reasoning techniques and technologies that employ probabilistic and/or statistical-based analysis to prognose or infer an action that a user desires to be automatically performed. The various embodiments presented herein can utilize various machine learning-based schemes for carrying out various aspects thereof. For example, a process for determining (a) the possibility of a dooring incident occurring and (b) the likelihood of vehicle 102 being involved/proximate to the dooring incident can be facilitated via an automatic classifier system and process. Hence, a classifier is trained to err on the side of caution, particularly given that a human life/injury may be at risk. E.g., where an inference is made that vehicle 102 may/may not be involved in a dooring incident, the classifier defers to vehicle 102 taking mitigating action (e.g., slows down, brakes, changes route).

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed (e.g., inference of a dooring incident occurring).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria a likelihood of a dooring incident occurring, and vehicle 102 being in the vicinity of the dooring incident.

As described supra, inferences can be made, and operations performed, based on numerous pieces of information. For example, as vehicle 102 navigates various streets, information regarding the actions/motions of cyclists, vehicle drivers/occupants negligently opening a door, likelihood of dooring occurring when a bike line is present versus when a bike lane is not present, a distance a cyclist may veer to avoid a door being opened, a route taken and/or response of a cyclist when cycling by parked cars (e.g., cyclist 120 rides bike 810 in bike lane 220 as far away from the parked vehicles 125 as possible without interfering with traffic), cyclist height, and suchlike. As the database of information accumulates (e.g., in memory 104) regarding interactions between cyclists and vehicles/drivers, the data is analyzed to determine converging patterns such that inferences can be made regarding dooring incidents, and, for example, the arbitrary settings presented in TABLE 1 can be further adjusted to mitigate dooring incidents and vehicle 102 being involved in their occurrence.

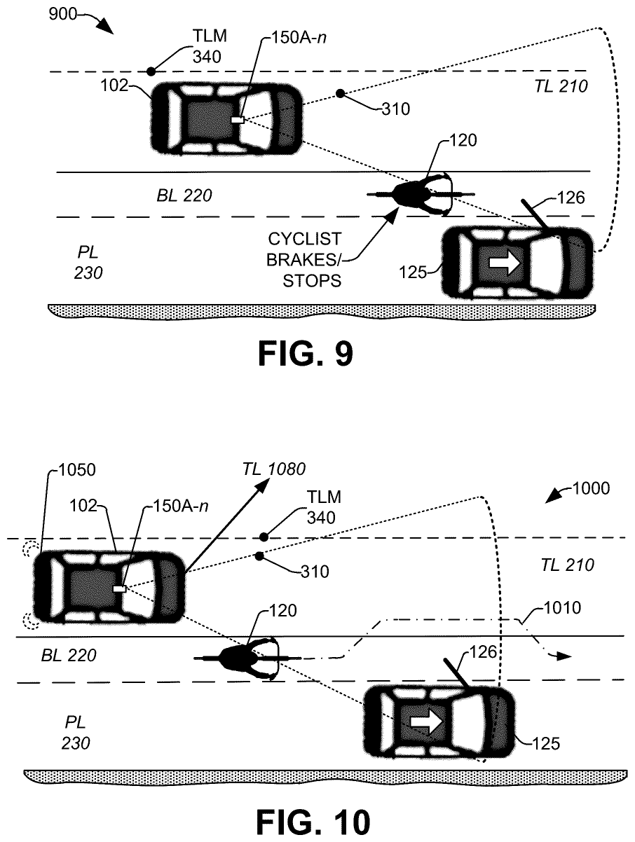

FIGS. 9, 10, and 11 present respective scenarios regarding operation of the vehicle 102 in response to various situations and/or actions undertaken by a cyclist 120 during a dooring incident, or a potential dooring incident, in accordance with one or more embodiments.

FIG. 9 presents a schematic 900 of an example scenario where a cyclist 120 brakes/stops in time to prevent colliding with vehicle door 126. In an embodiment, a bike lane 220 can be present between the parking lane 230 and the traffic lane 210. Accordingly, as the cyclist 120 is approaching the vehicle 125/door 126, the respective components included in the accident mitigation system 104 can detect the cyclist 120, with motion of vehicle 102 being slowed (e.g., based on a moderately safe/caution assessment and notification 166A-n between the accident component 165 and the vehicle operation components 140/braking component 148). Upon assessing the cyclist 120 has stopped/slowed down and no dooring incident will occur, vehicle 102 can navigate past cyclist 120. In an embodiment, as the vehicle 102 passes by cyclist 120, an audible device (e.g., a car horn, warning utterance, and suchlike) in device components 149 can be activated to let the cyclist 120 know that vehicle 102 is driving by.

FIG. 10 presents a schematic 1000 where a cyclist 120 changes their route to avoid hitting door 126. As shown in FIG. 10, a vehicle 125 is parked in the parking lane 230, with door 126 opened/opening. Cyclist 120 is navigating along bike lane 220 along route 1010, approaching vehicle 125. Cyclist 120 has sufficient time to avoid hitting the door 126, but in avoiding the door 126, the cyclist 120 ventures out of the bike lane 220 and veers into the traffic lane 210. As further shown, vehicle 102 is travelling behind the cyclist 120 and also approaching the vehicle 125. By veering into the traffic lane 210, the cyclist 120 is now effectively in the path of motion of the vehicle 102. As previously described, accident component 165 can be configured to determine the respective positions, velocities, etc., of vehicle 102 and cyclist 120 relative to each other and further relative to the location of vehicle 125. In an example scenario, vehicle 102 can be configured to perform any action to avoid hitting cyclist 120, wherein vehicle 102 can perform any of slow down, stop, engage hazard lights 1050, and suchlike. Further, if the conditions of road 205 are such that it is safe for vehicle 102 to move over to a traffic lane 1080 adjacent to traffic lane 210, the vehicle 102 can navigate into the adjacent traffic lane 1080 as it navigates past the cyclist 120. After the cyclist 120 has navigated around the vehicle 125/door 126, the cyclist 120 can return to cycling along bike lane 220 and resume their original route 1010. Similarly, once the vehicle 102 has navigated past the cyclist 120, when it is safe to do so, the vehicle 102 can return to driving in traffic lane 210.

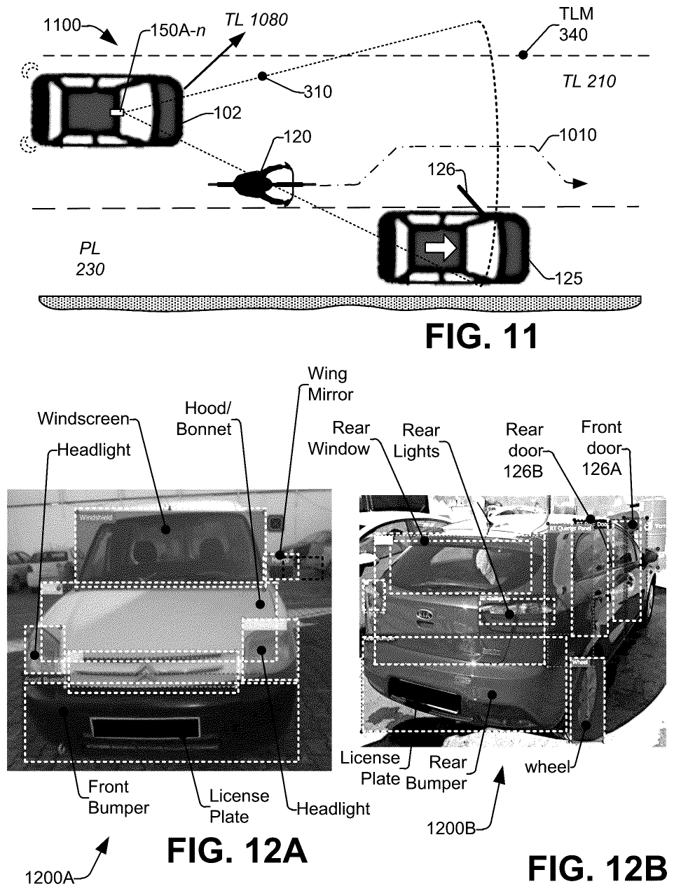

FIG. 11 presents a schematic 1100 depicting an example scenario of a cyclist 120 altering their route to avoid hitting door 126. The example scenario presented in FIG. 11 is similar to FIG. 10, however, in FIG. 11 the cyclist 120 is riding in the traffic lane 210 as there is no bike lane 220 (e.g., road 205 is too narrow to incorporate a bike lane 220). Hence, for cyclist 120 to avoid the door 126 of vehicle 125 parked at the side of road 205, the cyclist 120 has to further steer into the traffic lane 210, which places cyclist 120 in the path of vehicle 102. As previously described, accident component 165 can be configured to determine the respective positions, velocities, etc., of vehicle 102 and cyclist 120 relative to each other and further relative to the location of vehicle 125. In an example scenario, vehicle 102 can be configured to perform any action to avoid hitting cyclist 120, wherein vehicle 102 can perform any of slow down, stop, engage hazard lights 1050, and suchlike. Further, if the conditions of road 205 are such that it is safe for vehicle 102 to move over to a traffic lane 1080 adjacent to traffic lane 210, the vehicle 102 can navigate into the adjacent traffic lane 1080 as it navigates past the cyclist 120. After the cyclist 120 has navigated around the vehicle 125/door 126, the cyclist 120 can return to cycling along the side of traffic lane 210 and resume their original route 1010. Similarly, once the vehicle 102 has navigated past the cyclist 120, when it is safe to do so, the vehicle 102 can return to driving in traffic lane 210.

Various scenarios can be addressed by the various embodiments presented herein, including non-limiting examples:

(a) the distance between the vehicle 102 and the cyclist 120 can be sufficiently large such that the vehicle 102 would not be proximate to the cyclist 120 at a time when the cyclist 120 was proximate to the vehicle 125/door 126. Accident component 165 can assign a rating of safe to the example scenario. In such a scenario, the vehicle 102 can operate as normal and not take any responsive action regarding a possible dooring incident. The vehicle 102 would have sufficient time to perform a lane change (e.g., from traffic lane 210 into traffic lane 1080 and subsequently return to traffic lane 210. Also, the vehicle 102 would have sufficient time to avoid being proximate to/hitting cyclist 120. Further, the cyclist 120 has sufficient time to stop and prevent a dooring incident and/or navigate around the door 126 without issue of the vehicle 125 hitting the cyclist 120.

(b) the distance between the vehicle 102 and the cyclist 120 is short, with an according short period of time with which the vehicle 102 is proximate to the cyclist 120. Furthermore, the distance from the cyclist 120 to the door 126 is also short, such that the period of time available for the cyclist 120 to avoid a dooring incident is also short. Accordingly, the accident component 165 can make a determination that a dooring incident is likely/very likely to happen (e.g., an evaluation of dangerous, per TABLE 1). In response to the high probability of a dooring incident occurring, the accident component 165 can generate and transmit a notification 166A-n to any of (i) the braking component 148 (e.g., instructing the braking component 148 to reduce velocity and/or stop vehicle 102), (ii) the navigation component 142 (e.g., instructing the navigation component 142 to control steering of the vehicle 102 into an adjacent lane (e.g., from traffic lane 210 to traffic lane 1080), (iii) activate an audible alarm/warning by device component/devices 149, (iv) activate hazard lights (e.g., hazard lights 1050), and suchlike.

The various example scenarios presented throughout the application and the various embodiments regarding actions performed by the various components included in system 100 are interchangeable such that any scenario regarding dooring of cyclists and its mitigation is pertinent to the various embodiments.

As previously mentioned, the respective features of vehicles 125A-n can be identified by vehicle 102, e.g., to determine a direction in which a vehicle 125A-n is respectively parked facing and further location of one or more doors on the respective vehicles 125A-n. FIGS. 12A and 12B present images 1200A and 1200B showing analysis and identification of components comprising a parked vehicle, in accordance with an embodiment. As shown in images 1200A and 1200B, various components can be identified, e.g., windshield, headlight(s), front and rear bumpers, hood/bonnet, wing mirror, wheel(s), rear window, rear light(s), front door 126A, rear door 126B, and suchlike. Further, the dimensions of the parked vehicle can be determined (e.g., per vehicle data in vehicle database 180) based upon make and model identifiers of the parked vehicle such as a manufacturer's badge on the radiator grill and/or rear trunk, and suchlike. The respective components in the images 1200A and 1200B can be identified by computer vision algorithm 164A.

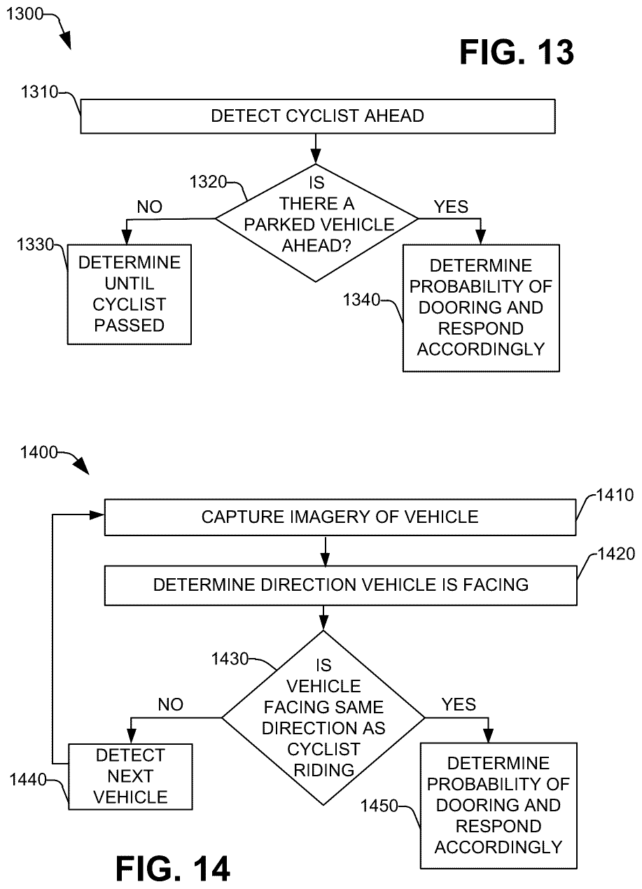

FIG. 13 illustrates a flow diagram 1300 for a computer-implemented methodology to mitigate involvement of a first vehicle in a car dooring incident, in accordance with at least one embodiment.

At 1310, while the first vehicle (e.g., vehicle 102) is navigating a road (e.g., road 205), the first vehicle can detect (e.g., by cyclist component 158) a presence of a cyclist (e.g., cyclist 120) also navigating the road. In an embodiment, the cyclist can be in front of the first vehicle, wherein the cyclist can be determined to be travelling in a same direction as the first vehicle (e.g., both the first vehicle and the cyclist are travelling westbound along the road), or the cyclist can be further determined to be travelling in a direction towards the first vehicle (e.g., the first vehicle is travelling west along the road, while the cyclist is travelling cast along the road). In an embodiment, the cyclist can be cycling in a bike lane (e.g., bike lane 220) or the cyclist can be cycling in a traffic lane (e.g., traffic lane 210), wherein the first vehicle is also driving in the traffic lane. In an embodiment, a bike lane may not be present and the cyclist is cycling in the traffic lane. In an example embodiment, the first vehicle can be operating in at least a partially autonomous manner.

At 1320, the first vehicle can further detect whether there is a second vehicle (e.g., vehicle 125) parked proximate to the cyclist or further ahead from the cyclist, wherein the second vehicle can be parked in a parking lane (e.g., parking lane 230). In an embodiment, the bike lane can be located between the traffic lane and the parking lane. In another embodiment, neither a bike lane or a parking may be present, e.g., vehicles parked on side of road, cyclist is riding in traffic lane, and suchlike. In another embodiment, the vehicle may be parked in the bike lane.

At 1320, in response to a determination of NO, there is no vehicle parked ahead, methodology 1300 can advance to 1330, wherein the first vehicle can continue to review whether there are no vehicles parked ahead of the cyclist until the first vehicle has passed the cyclist.

At 1320, in response to a determination of YES, there is a vehicle parked proximate to/ahead of the cyclist, methodology 1300 can advance to 1340, wherein the first vehicle further monitor motion of at least one of the cyclist and the first vehicle to enable a determination of at least one of a probability of a dooring incident occurring between the cyclist and the parked vehicle or a probability of the first vehicle being proximate to the cyclist when the dooring incident has potential to occur.

FIG. 14 illustrates a flow diagram 1400 for a computer-implemented methodology for detection of a direction a vehicle is facing when parked and/or being parked, relative to a direction being navigated by a cyclist, in accordance with at least one embodiment.

At 1410, imagery of a parked vehicle (e.g., any of vehicles 125A-n) can be captured (e.g., by sensors/cameras 150A-n). As previously mentioned, the imagery can be digital images captured by a camera, along with other sensing data (e.g., heat detection from an engine, an exhaust) captured using IR sensors and suchlike, onboard a first vehicle (e.g., vehicle 102). In an example scenario, the first vehicle can be operating in at least a partially autonomous manner.

At 1420, a direction in which the parked vehicle is facing can be determined. The direction can be based upon the imagery of the parked vehicle, wherein the presence of various components of the vehicle (e.g., headlights, windscreen, door(s), wheels, and suchlike) can be identified (e.g., by the vehicle detection component 163 in conjunction with algorithms 164A-n analyzing the captured imagery). In an example determination, the parked vehicle can be identified as being parked facing towards the first vehicle, or away from the first vehicle.

At 1430, in an embodiment, a direction in which a cyclist (e.g., cyclist 120) is riding their bike can be determined. As previously mentioned, the onboard sensors located on the first vehicle can provide data to detect the presence (e.g., by cyclist component 158) of the cyclist in the vicinity of the first vehicle, in conjunction with a direction of travel, speed of travel, predicted time to reach a particular location (e.g., a door 126 of the parked vehicle), and suchlike. At 1430, in response to a determination (e.g., by the accident component 165 based on data provided by the cyclist component 158 and vehicle detection component 163) that NO, the parked vehicle and the cyclist are not facing the same direction, methodology 1400 can advance to 1440. Owing to the reduced, safe likelihood of a dooring incident occurring when a cyclist is cycling towards a vehicle, can be seen by the driver, and further can respond to the driver's actions (e.g., opening the door 126 to egress the vehicle 125), the vehicle detection methodology can further attempt to detect another vehicle (e.g., the next vehicle to be passed by the cyclist), wherein methodology 1400 can return to step 1410 to detect the next vehicle and determine a likelihood of a dooring incident occurring as a function of the direction the parked vehicle is facing.

Returning to 1430, in response to a determination (e.g., by the accident component 165) of YES, the cyclist and vehicle are facing in the same direction, methodology 1400 can advance to 1450, wherein the probability of a dooring incident occurring can be determined (e.g., by accident component 165). As mentioned, where a vehicle is parked facing away from the path of a cyclist, the driver/occupant of the vehicle may not see the cyclist prior to opening the door, wherein the driver/occupant is negligent in not looking out for a possible cyclist (e.g., by looking in a rearview mirror, not performing a Dutch Reach/far hand method). As further mentioned, the probability of a dooring incident occurring can be based on the speed of the cyclist leading to insufficient time for the cyclist to respond to a door opening, and further, in the event of a possible dooring, the first vehicle can determine a probability of the first vehicle being proximate (e.g., likelihood of hitting the cyclist) when the potential dooring event occurs. In response to a determination (e.g., by accident component 165) of a low, safe probability of a dooring event occurring (e.g., cyclist has sufficient time to avoid a dooring, first vehicle is too far away from the potential incident to be involved in furthering the accident, for example, hitting the falling cyclist) methodology 1400 can return to 1410 to determine a probability of a dooring occurring based on the next parked vehicle. In response to a determination (e.g., by accident component 165) of a high probability (e.g., situation is assessed as dangerous) that a dooring incident could occur, the first vehicle can perform any of reducing velocity, stopping, turning on hazard lights, sending out an audible warning to the driver of the parked vehicle “cyclist approaching”, altering direction of travel to avoid the cyclist in response to a possibility that the cyclist falls during a dooring incident and/or navigates to avoid the dooring incident.

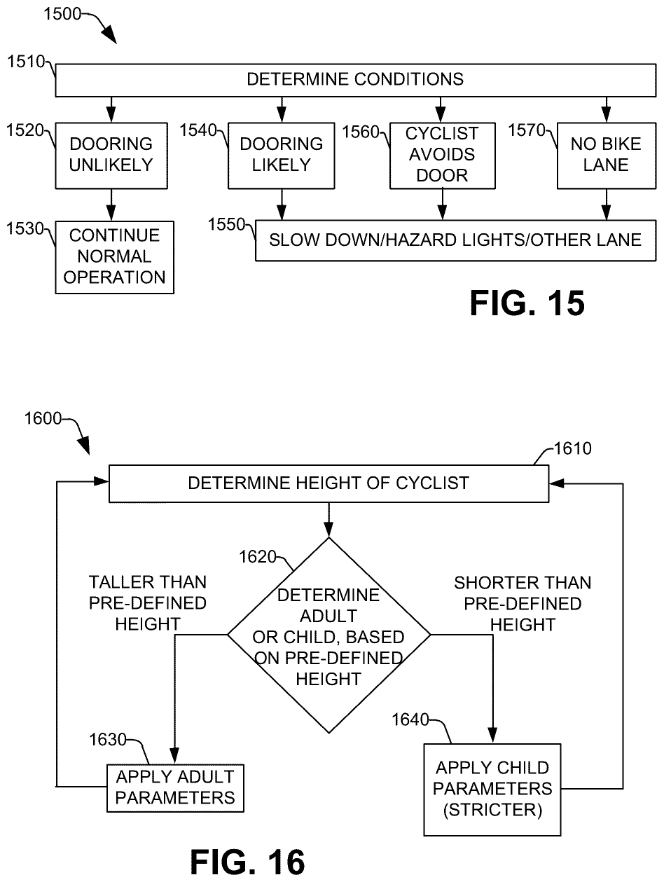

FIG. 15 illustrates a flow diagram 1500 for a computer-implemented methodology to determine probability/likelihood of a dooring incident occurring, and responsive action(s), in accordance with at least one embodiment.

At 1510, a determination can be made (e.g., by accident component 165) by a first vehicle (e.g., vehicle 102) regarding current riding conditions of a cyclist and probability of a dooring incident occurring, and one or more actions that can be taken in response to the probability of a dooring incident occurring is low/safe to non-existent, through to one or more actions that can be taken in response to the probability of a dooring being possible/moderate likelihood through to a high probability/dangerous of a dooring incident occurring.

At 1520, a determination can be made (e.g., by accident component 165) that a dooring event is unlikely/safe. The determination can be based on the cyclist has sufficient time to respond to a door (e.g., door 126) being opened, the vehicle is parked facing a direction that is not conducive to a dooring incident, the cyclist has sufficient space to navigate around the opening door without overly moving into the path of vehicle, and suchlike. In response to determination of dooring incident being unlikely/safe, methodology 1500 can advance to 1520, wherein the first vehicle can continue without having to adjust operation owing to the low probability of a dooring incident.

At 1540, a determination can be made (e.g., by accident component 165) that there is a moderate likelihood of a dooring incident occurring. In response to such a determination, methodology can advance to 1550, wherein a variety of operations and responses can be undertaken by the first vehicle (e.g., by an accident component 165 generating a notification 166A-n of a dooring incident having moderate probability). Such operations can include first vehicle slowing down, first vehicle assessing possibility of navigating around the cyclist and/or location of possible dooring incident occurring, first vehicle transmitting an audible warning to either of the cyclist and/or the driver/occupant of the parked vehicle, and suchlike.

At 1560, in response to a determination (e.g., by accident component 165) that there is a high/dangerous probability of a dooring incident occurring, the methodology 1500 can also advance to 1550 wherein the prior mentioned actions can also include the first vehicle stopping, moving to an adjacent lane to avoid the cyclist during the dooring incident and suchlike. Further, as previously described, the first vehicle can also maneuver to take into account that a bike lane does not exist, and suchlike.

FIG. 16 illustrates a flow diagram 1600 for a computer-implemented methodology to determine a height H of a cyclist and adjust probabilities of a dooring incident and response thereto, in accordance with at least one embodiment.

At 1610, as previously described, the height H of a cyclist (e.g., cyclist 120) can be determined (e.g., by cyclist component 158 in conjunction with information captured by sensors 150A-n, such as digital images from a camera, as processed by imaging algorithms 164A-n).

At 1620, a determination can be made regarding whether the cyclist is an adult or a child. In an embodiment, the adult/child determination can be conducted based on the determined height in comparison with a pre-defined value, wherein the pre-defined can be an arbitrary value, e.g., 150 cm. In response to a determination that H>150 cm, the cyclist can be assessed as an adult and the probability settings and according response by the vehicle (e.g., accident component 165 and associated components onboard vehicle 102), as detailed in TABLE 1 can be applied. Methodology 1600 can return to 1610 for a subsequent determination of child height.

Returning to step 1620, in response to a determination that the height of the cyclist is ≤150 cm, the cyclist can be assessed as a child, the probability settings can be made stricter/tightened and according response by the vehicle (e.g., accident component 165 and associated components onboard vehicle 102), as detailed in TABLE 1 can be applied, e.g., treat a moderate situation for a child as dangerous. Methodology 1600 can return to 1610 for a subsequent determination of a cyclist's height.

### Example Applications and Use

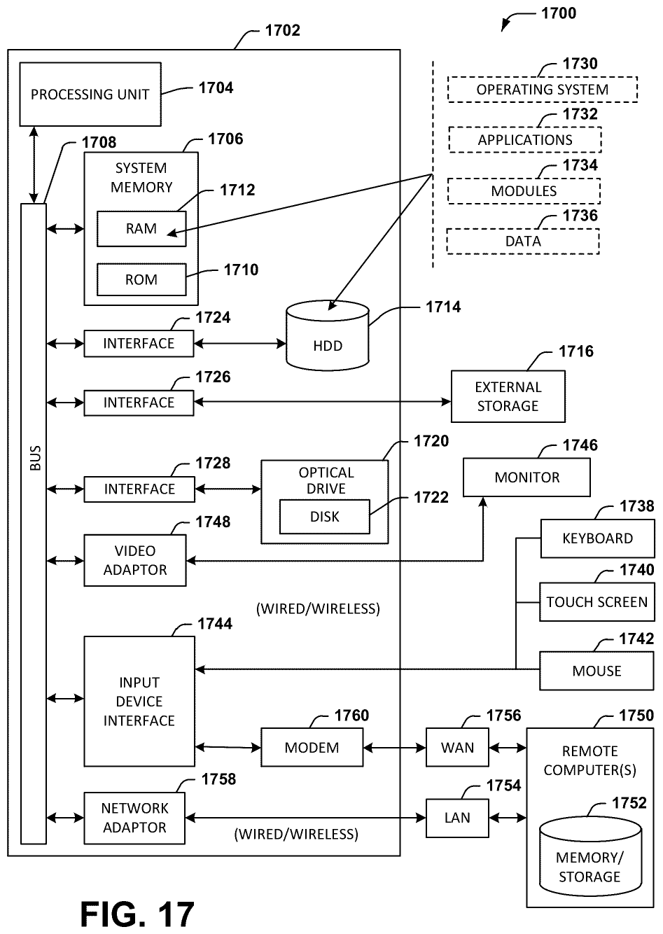

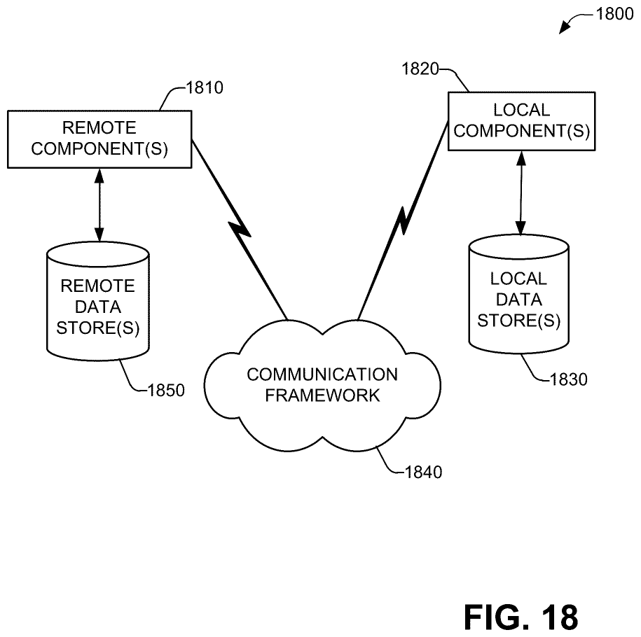

Turning next to FIGS. 17 and 18, a detailed description is provided of additional context for the one or more embodiments described herein with FIGS. 1-16.

In order to provide additional context for various embodiments described herein, FIG. 17 and the following discussion are intended to provide a brief, general description of a suitable computing environment 1700 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 17, the example environment 1700 for implementing various embodiments of the aspects described herein includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors and may include a cache memory. Dual microprocessors and other multi-processor architectures can also be employed as the processing unit 1704.

The system bus 1708 can be any of several types of bus structure that can further interconnect to a memory bus (with or without a memory controller), a peripheral bus, and a local bus using any of a variety of commercially available bus architectures. The system memory 1706 includes ROM 1710 and RAM 1712. A basic input/output system (BIOS) can be stored in a non-volatile memory such as ROM, erasable programmable read only memory (EPROM), EEPROM, which BIOS contains the basic routines that help to transfer information between elements within the computer 1702, such as during startup. The RAM 1712 can also include a high-speed RAM such as static RAM for caching data.

The computer 1702 further includes an internal hard disk drive (HDD) 1714 (e.g., EIDE, SATA), one or more external storage devices 1716 (e.g., a magnetic floppy disk drive (FDD) 1716, a memory stick or flash drive reader, a memory card reader, etc.) and an optical disk drive 1720 (e.g., which can read or write from a CD-ROM disc, a DVD, a BD, etc.). While the internal HDD 1714 is illustrated as located within the computer 1702, the internal HDD 1714 can also be configured for external use in a suitable chassis (not shown). Additionally, while not shown in environment 1700, a solid-state drive (SSD) could be used in addition to, or in place of, an HDD 1714. The HDD 1714, external storage device(s) 1716 and optical disk drive 1720 can be connected to the system bus 1708 by an HDD interface 1724, an external storage interface 1726 and an optical drive interface 1728, respectively. The interface 1724 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. The systems and methods described herein can be implemented utilizing various commercially available operating systems or combinations of operating systems.

Computer 1702 can optionally comprise emulation technologies. For example, a hypervisor (not shown) or other intermediary can emulate a hardware environment for operating system 1730, and the emulated hardware can optionally be different from the hardware illustrated in FIG. 17. In such an embodiment, operating system 1730 can comprise one virtual machine (VM) of multiple VMs hosted at computer 1702. Furthermore, operating system 1730 can provide runtime environments, such as the Java runtime environment or the .NET framework, for applications 1732. Runtime environments are consistent execution environments that allow applications 1732 to run on any operating system that includes the runtime environment. Similarly, operating system 1730 can support containers, and applications 1732 can be in the form of containers, which are lightweight, standalone, executable packages of software that include, e.g., code, runtime, system tools, system libraries and settings for an application.

Further, computer 1702 can comprise a security module, such as a trusted processing module (TPM). For instance with a TPM, boot components hash next in time boot components, and wait for a match of results to secured values, before loading a next boot component. This process can take place at any layer in the code execution stack of computer 1702, e.g., applied at the application execution level or at the operating system (OS) kernel level, thereby enabling security at any level of code execution.

A user can enter commands and information into the computer 1702 through one or more wired/wireless input devices, e.g., a keyboard 1738, a touch screen 1740, and a pointing device, such as a mouse 1742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1704 through an input device interface 1744 that can be coupled to the system bus 1708, but can be connected by other interfaces, such as a parallel port, an IEEE 1794 serial port, a game port, a USB port, an IR interface, a BLUETOOTH® interface, etc.

A monitor 1746 or other type of display device can be also connected to the system bus 1708 via an interface, such as a video adapter 1748. In addition to the monitor 1746, a computer typically includes other peripheral output devices (not shown), such as speakers, printers, etc.

The computer 1702 can operate in a networked environment using logical connections via wired and/or wireless communications to one or more remote computers, such as a remote computer(s) 1750. The remote computer(s) 1750 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1752 is illustrated. The logical connections depicted include wired/wireless connectivity to a local area network (LAN) 1754 and/or larger networks, e.g., a wide area network (WAN) 1756. Such LAN and WAN networking environments are commonplace in offices and companies, and facilitate enterprise-wide computer networks, such as intranets, all of which can connect to a global communications network, e.g., the internet.

When used in a LAN networking environment, the computer 1702 can be connected to the local network 1754 through a wired and/or wireless communication network interface or adapter 1758. The adapter 1758 can facilitate wired or wireless communication to the LAN 1754, which can also include a wireless access point (AP) disposed thereon for communicating with the adapter 1758 in a wireless mode.

When used in a WAN networking environment, the computer 1702 can include a modem 1760 or can be connected to a communications server on the WAN 1756 via other means for establishing communications over the WAN 1756, such as by way of the internet. The modem 1760, which can be internal or external and a wired or wireless device, can be connected to the system bus 1708 via the input device interface 1744. In a networked environment, program modules depicted relative to the computer 1702 or portions thereof, can be stored in the remote memory/storage device 1752. It will be appreciated that the network connections shown are example and other means of establishing a communications link between the computers can be used.

When used in either a LAN or WAN networking environment, the computer 1702 can access cloud storage systems or other network-based storage systems in addition to, or in place of, external storage devices 1716 as described above. Generally, a connection between the computer 1702 and a cloud storage system can be established over a LAN 1754 or WAN 1756 e.g., by the adapter 1758 or modem 1760, respectively. Upon connecting the computer 1702 to an associated cloud storage system, the external storage interface 1726 can, with the aid of the adapter 1758 and/or modem 1760, manage storage provided by the cloud storage system as it would other types of external storage. For instance, the external storage interface 1726 can be configured to provide access to cloud storage sources as if those sources were physically connected to the computer 1702.

The computer 1702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 18, an illustrative cloud computing environment 1800 is depicted. FIG. 18 is a schematic block diagram of a computing environment 1800 with which the disclosed subject matter can interact. The system 1800 comprises one or more remote component(s) 1810. The remote component(s) 1810 can be hardware and/or software (e.g., threads, processes, computing devices). In some embodiments, remote component(s) 1810 can be a distributed computer system, connected to a local automatic scaling component and/or programs that use the resources of a distributed computer system, via communication framework 1840. Communication framework 1840 can comprise wired network devices, wireless network devices, mobile devices, wearable devices, radio access network devices, gateway devices, femtocell devices, servers, etc.

The system 1800 also comprises one or more local component(s) 1820. The local component(s) 1820 can be hardware and/or software (e.g., threads, processes, computing devices). In some embodiments, local component(s) 1820 can comprise an automatic scaling component and/or programs that communicate/use the remote resources 1810 and 1820, etc., connected to a remotely located distributed computing system via communication framework 1840.

One possible communication between a remote component(s) 1810 and a local component(s) 1820 can be in the form of a data packet adapted to be transmitted between two or more computer processes. Another possible communication between a remote component(s) 1810 and a local component(s) 1820 can be in the form of circuit-switched data adapted to be transmitted between two or more computer processes in radio time slots. The system 1800 comprises a communication framework 1840 that can be employed to facilitate communications between the remote component(s) 1810 and the local component(s) 1820, and can comprise an air interface, e.g., Uu interface of a UMTS network, via a long-term evolution (LTE) network, etc. Remote component(s) 1810 can be operably connected to one or more remote data store(s) 1850, such as a hard drive, solid state drive, SIM card, device memory, etc., that can be employed to store information on the remote component(s) 1810 side of communication framework 1840. Similarly, local component(s) 1820 can be operably connected to one or more local data store(s) 1830, that can be employed to store information on the local component(s) 1820 side of communication framework 1840.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

While not an exhaustive listing, summarizing various embodiments, but not all embodiments, presented herein:

1. A system, located on a first vehicle, comprising: a memory that stores computer executable components; and a processor that executes the computer executable components stored in the memory, wherein the computer executable components comprise: an accident component configured to: determine probability of a cyclist being involved in a dooring incident, wherein the cyclist is cycling on a road the first vehicle is navigating; determine a proximity of the first vehicle to an inferred location of the dooring incident; and in response to a first determination that the determined probability is above a probability threshold, generate a first instruction for the first vehicle to preemptively avoid hitting the cyclist.

2. The system of claim 1, wherein the first instruction comprises at least one of: reduce velocity of the first vehicle; stop motion of the first vehicle; or navigate the first vehicle to avoid the cyclist.

3. The system of claim 1, further comprising a vehicle detection component configured to: detect a presence of a parked vehicle; in response to detecting the presence of the parked vehicle, determine a direction in which the parked vehicle is facing; and transmit a notification of the parked vehicle being detected and the direction that the parked vehicle is facing.

4. The system of claim 3, wherein the vehicle detection component is further configured to determine location of a door on the parked vehicle, wherein the door is proximate to a route being navigated by the cyclist.

5. The system of claim 4, further comprising a cyclist component configured to: determine speed of travel of the cyclist; determine direction of travel of the cyclist; and transmit a notification of the determined speed of travel of the cyclist and the determined direction of travel of the cyclist.

6. The system of claim 5, further comprising a vehicle operation component configured to: generate a current speed of the first vehicle; a direction of travel of the first vehicle; and report the current speed of the first vehicle and the direction of travel of the first vehicle to the accident component.

7. The system of claim 6, wherein the accident component is further configured to determine probability of a cyclist being involved in a dooring incident based on at least one of: the parked vehicle is parked facing the direction of travel the cyclist is riding; the speed of the cyclist; a first time at which the cyclist will be proximate to the door of the parked vehicle; a speed of the first vehicle; or a second time at which the first vehicle will be proximate to the door of the parked vehicle.

8. The system of claim 7, wherein the accident component is further configured to: in response to a determination that the first time at which the cyclist is proximate to the door of the parked vehicle is less than a first elapsed time and the second time at which the first vehicle will be proximate to the door of the parked vehicle is less than a second elapsed time generate the first instruction to preemptively avoid hitting the cyclist.

9. The system of claim 8, wherein the first elapsed time is less than three seconds, and the second elapsed time is less than three seconds.

10. The system of claim 1, wherein, in response to the determination that the determined probability is below the probability threshold, the accident component can be further configured to generate a second instruction to maintain current operation of the first vehicle.

11. The system of claim 1, further comprising a cyclist component configured to determine a height of the cyclist, wherein: in response to the height of the cyclist being above a height threshold, the cyclist is determined to be an adult; or in response to the height of the cyclist being below a height threshold, the cyclist is determined to be a child.

12. The system of claim 1, wherein the first vehicle is operating at least in a partially autonomously.

13. A method comprising: detecting, by a device comprising a processor located on a first vehicle wherein the first vehicle is operating at least in a partially autonomous manner, a presence of a cyclist riding along a road being navigated by the first vehicle; detecting a vehicle parked on the road; determining a direction in which the parked vehicle is facing; and in response to determining the parked vehicle is facing the same direction as a direction of travel of the cyclist, determining a probability of a dooring incident occurring between the cyclist and the parked vehicle.

14. The method of claim 13, further comprising: determining a first time at which the cyclist will be proximate at the parked vehicle; determining a second time at which the first vehicle will be proximate to first vehicle; and in the event of the first time and the second time being substantially the same, operating the first vehicle to at least one of: reduce velocity of the first vehicle; stop motion of the first vehicle; or navigate the first vehicle to avoid the cyclist.

15. The method of claim 14, further comprising: in the event of the first time and the second time not being substantially the same, maintaining current operation of the first vehicle.

16. The method of claim 14, wherein the determining of the first time at which the cyclist will be proximate at the parked vehicle is based on at least one of: an inference of speed of travel of the cyclist; or an inference of direction of travel of the cyclist; and the determining of the second time at which the first vehicle will be proximate at the parked vehicle is based on at least one of: speed of travel of the first vehicle; or direction of travel of the first vehicle.

17. A computer program product comprising a computer readable storage medium having program instructions embodied therewith, the program instructions executable by a processor to cause the processor to: determine, by a device comprising a processor located on a first vehicle wherein the first vehicle is operating at least in a partially autonomous manner, a presence of a cyclist riding along a road being navigated by the first vehicle; determine a vehicle is parked on the road; determine a direction in which the parked vehicle is facing; and in response to determining the parked vehicle is facing the same direction as a direction of travel of the cyclist, determine a probability of a dooring incident occurring between the cyclist and the parked vehicle.

18. The computer program product of claim 17, wherein the program instructions are further executable by the processor to cause the processor to: determine a first time at which the cyclist will be proximate at the parked vehicle; determine a second time at which the first vehicle will be proximate to first vehicle; and in the event of the first time and the second time being substantially the same, operate the first vehicle to at least one of: reduce velocity of the first vehicle; stop motion of the first vehicle; or navigate the first vehicle to avoid the cyclist.

19. The computer program product of claim 18, wherein in the event of the first time and the second time not being substantially the same, the program instructions are further executable by the processor to cause the processor to maintain current operation of the first vehicle.

20. The computer program product of claim 18, wherein the determination of the first time at which the cyclist will be proximate at the parked vehicle is based on at least one of: an inference of speed of travel of the cyclist; or an inference of direction of travel of the cyclist; and the determination of the second time at which the first vehicle will be proximate at the parked vehicle is based on at least one of: speed of travel of the first vehicle; or direction of travel of the first vehicle.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, located on a first vehicle, comprising:
a memory that stores computer executable components; and
a processor that executes the computer executable components stored in the memory, wherein the computer executable components comprise:
an accident component configured to:
determine probability of a cyclist being involved in a dooring incident, wherein the cyclist is cycling on a road the first vehicle is navigating;
determine a proximity of the first vehicle to an inferred location of the dooring incident; and
in response to a first determination that the determined probability is above a probability threshold, generate a first instruction for the first vehicle to preemptively avoid hitting the cyclist.

2. The system of claim 1, wherein the first instruction comprises at least one of:
reduce velocity of the first vehicle;
stop motion of the first vehicle; or
navigate the first vehicle to avoid the cyclist.

3. The system of claim 1, further comprising a vehicle detection component configured to:
detect a presence of a parked vehicle;
in response to detecting the presence of the parked vehicle, determine a direction in which the parked vehicle is facing; and
transmit a notification of the parked vehicle being detected and the direction that the parked vehicle is facing.

4. The system of claim 3, wherein the vehicle detection component is further configured to determine location of a door on the parked vehicle, wherein the door is proximate to a route being navigated by the cyclist.

5. The system of claim 4, further comprising a cyclist component configured to:
determine speed of travel of the cyclist;
determine direction of travel of the cyclist; and
transmit a notification of the determined speed of travel of the cyclist and the determined direction of travel of the cyclist.

6. The system of claim 5, further comprising a vehicle operation component configured to:
generate a current speed of the first vehicle;
a direction of travel of the first vehicle; and
report the current speed of the first vehicle and the direction of travel of the first vehicle to the accident component.

7. The system of claim 6, wherein the accident component is further configured to determine probability of a cyclist being involved in a dooring incident based on at least one of:
the parked vehicle is parked facing the direction of travel the cyclist is riding;
the speed of the cyclist;
a first time at which the cyclist will be proximate to the door of the parked vehicle;
a speed of the first vehicle; or
a second time at which the first vehicle will be proximate to the door of the parked vehicle.

8. The system of claim 7, wherein the accident component is further configured to:
in response to a determination that the first time at which the cyclist is proximate to the door of the parked vehicle is less than a first elapsed time and the second time at which the first vehicle will be proximate to the door of the parked vehicle is less than a second elapsed time generate the first instruction to preemptively avoid hitting the cyclist.

9. The system of claim 8, wherein the first elapsed time is less than three seconds, and the second elapsed time is less than three seconds.

10. The system of claim 1, wherein, in response to the determination that the determined probability is below the probability threshold, the accident component can be further configured to generate a second instruction to maintain current operation of the first vehicle.

11. The system of claim 1, further comprising a cyclist component configured to determine a height of the cyclist, wherein:
in response to the height of the cyclist being above a height threshold, the cyclist is determined to be an adult; or
in response to the height of the cyclist being below a height threshold, the cyclist is determined to be a child.

12. The system of claim 1, wherein the first vehicle is operating at least in a partially autonomously.

13. A method comprising:
detecting, by a device comprising a processor located on a first vehicle wherein the first vehicle is operating at least in a partially autonomous manner, a presence of a cyclist riding along a road being navigated by the first vehicle;
detecting a vehicle parked on the road;
determining a direction in which the parked vehicle is facing; and
in response to determining the parked vehicle is facing the same direction as a direction of travel of the cyclist, determining a probability of a dooring incident occurring between the cyclist and the parked vehicle.

14. The method of claim 13, further comprising:
determining a first time at which the cyclist will be proximate at the parked vehicle;
determining a second time at which the first vehicle will be proximate to first vehicle; and
in the event of the first time and the second time being substantially the same, operating the first vehicle to at least one of:
reduce velocity of the first vehicle;
stop motion of the first vehicle; or
navigate the first vehicle to avoid the cyclist.

15. The method of claim 14, further comprising:
in the event of the first time and the second time not being substantially the same, maintaining current operation of the first vehicle.

16. The method of claim 14, wherein the determining of the first time at which the cyclist will be proximate at the parked vehicle is based on at least one of:
an inference of speed of travel of the cyclist; or
an inference of direction of travel of the cyclist; and
the determining of the second time at which the first vehicle will be proximate at the parked vehicle is based on at least one of:
speed of travel of the first vehicle; or
direction of travel of the first vehicle.

17. A computer program product comprising a computer readable storage medium having program instructions embodied therewith, the program instructions executable by a processor to cause the processor to:
determine, by a device comprising a processor located on a first vehicle wherein the first vehicle is operating at least in a partially autonomous manner, a presence of a cyclist riding along a road being navigated by the first vehicle;
determine a vehicle is parked on the road;
determine a direction in which the parked vehicle is facing; and
in response to determining the parked vehicle is facing the same direction as a direction of travel of the cyclist, determine a probability of a dooring incident occurring between the cyclist and the parked vehicle.

18. The computer program product of claim 17, wherein the program instructions are further executable by the processor to cause the processor to:
determine a first time at which the cyclist will be proximate at the parked vehicle;
determine a second time at which the first vehicle will be proximate to first vehicle; and
in the event of the first time and the second time being substantially the same, operate the first vehicle to at least one of:
reduce velocity of the first vehicle;
stop motion of the first vehicle; or
navigate the first vehicle to avoid the cyclist.

19. The computer program product of claim 18, wherein in the event of the first time and the second time not being substantially the same, the program instructions are further executable by the processor to cause the processor to maintain current operation of the first vehicle.

20. The computer program product of claim 18, wherein the determination of the first time at which the cyclist will be proximate at the parked vehicle is based on at least one of:
an inference of speed of travel of the cyclist; or
an inference of direction of travel of the cyclist; and
the determination of the second time at which the first vehicle will be proximate at the parked vehicle is based on at least one of:
speed of travel of the first vehicle; or
direction of travel of the first vehicle.
